(19) United States
(12) Patent Application Publication
(10) Pub. No.: US 2011/0307318 A1
(43) Pub. Date: Dec. 15, 2011

(54) MOBILE RETAIL LOYALTY NETWORK

(76) Inventors: Jeffrey LaPorte, Vancouver (CA); Nigel Malkin, Vancouver (CA)

(21) Appl. No.: 13/158,166

(22) Filed: Jun. 10, 2011

Related U.S. Application Data
(60) Provisional application No. 61/354,140, filed on Jun. 11, 2010.

(51) Int. Cl. G06Q 30/00

(52) U.S. Cl. 705/14.33; 705/14.27; 705/24; 705/14.38

(57) ABSTRACT

A loyalty network enables customers to use their mobile devices to participate in a merchant's customer loyalty program. When a customer conducts a transaction, the merchant's point-of-sale (POS) system generates a code image containing transaction information. The POS system may print the code image on a transaction record (such as a bill or receipt) provided to the customer, and/or may display the code image on a display screen. The customer can then photograph/scan the code image with their mobile device, which sends the transaction information and authentication information to a loyalty program server. The loyalty program server may use this information to credit the customer's loyalty program account, and may, in some cases, interact with the POS system to enable loyalty program credits to be redeemed. In some embodiments, the transaction information may alternatively be conveyed to the mobile device using Near Field Communications.

### CROSS-REFERENCE TO RELATED APPLICATIONS

This application claims the benefit of U.S. Provisional Application No. 61/354,140, entitled System and Method for Mobile Retail Loyalty Network, filed on Jun. 11, 2010, the disclosure of which is hereby incorporated by reference herein.

### BACKGROUND

This disclosure relates generally to the field of customer loyalty systems, and specifically to customer loyalty systems integrated with point-of-sale systems. The disclosure also relates to methods for enabling customers to capture point-of-sale transaction information with their mobile devices.

In an increasingly competitive marketplace, the ability to retain customers is a significant concern for many businesses. Usually, retaining customers is less expensive than attracting new customers, and developing customer loyalty is an important step in that retention effort. To address the challenge of retaining customers and developing customer loyalty, various loyalty systems and products have been developed to help businesses increase customer loyalty.

For example, many fast-food restaurants pass out loyalty punch cards. The goal of loyalty punch cards is to encourage the customer to visit the restaurant repeatedly, with the promise of a free meal, or some other discount, after having visited a certain number of times. A customer with such a punch card will thus theoretically visit the same restaurant repeatedly in anticipation of eventually getting their reward. Such a loyalty system requires, however, that the customer constantly retain the loyalty punch card and remember to bring the card with them on each visit. Frequently forgetting, or worse, losing the card creates significant customer frustration because the loyalty program must be restarted from the beginning Additionally, a customer who is interested in joining many loyalty programs faces the significant inconvenience of having to carry many cards with them at all times.

As another example, many stores print out coupons on the back of the customer's receipt following a purchase. The coupons encourage the customer to return to the store with the promise of a discount on future purchases. As with the loyalty punch cards, however, the future discount is contingent on the customer remembering to bring the coupons with them on a subsequent visit. A customer is also faced with the prospect of retaining large numbers of paper coupons, organized by each store they frequent.

Most existing customer loyalty programs and systems, such as the two previously described, require the customer to carry with them an additional object (for example, a card, a coupon, or key chain). Each retailer, additionally, requires their own unique object. Typical loyalty systems also add an additional step to the transaction process between the customer and the retailer. In the loyalty punch card system, the customer and the retailer must remember to punch the card as part of the transaction. In the coupon system, the retailer must scan the coupons during the transaction. These systems thus add time and complexity to the transaction process.

### SUMMARY

A customer loyalty system is disclosed that enables customers of a merchant to use their smartphones or other mobile devices to participate in a customer loyalty program. In some embodiments, when a customer conducts a transaction, the merchant's point-of-sale (POS) system generates a code image, such as a QR (Quick Response) code or other bar code, containing transaction information associated with the transaction. The POS system may print the code image on a transaction record (such as a bill or receipt) provided to the customer, and/or may display the code image on a display screen. The customer can then photograph/scan the code image with their mobile device, using either a loyalty program application or a generic code reader application. The mobile device then sends the extracted transaction information and customer authentication information to a loyalty program server (typically operated by a loyalty program service provider), which uses the information to credit a loyalty program account of the customer. In some embodiments, the loyalty program server may also communicate with the POS system to retrieve additional information regarding the transaction.

Various options may be provided for customers to redeem loyalty program credits. For example, in one embodiment in which the code image is printed on a bill, the customer is given an option, via the mobile device, to redeem loyalty program credits to reduce the amount of the bill. If the customer opts to redeem loyalty program credits toward the bill, the loyalty program server may send an update message to the POS system, causing the amount of the bill to be reduced. As another example, the customer's loyalty program credits may be applied to the transaction automatically (without further interaction with the customer). As yet another example, loyalty program credits may be redeemed (automatically or based on a customer selection) for a stored value card, gift certificate or coupon that can be used for subsequent transactions with the merchant

In addition or as an alternative to providing a code image to the customer, the POS terminal may include a Near Field Communications (NFC) pad for conveying the transaction information to the customer's mobile device. Thus, rather than photographing a code image, the customer may hold the mobile device close to the NFC pad to allow the mobile device to capture the transaction information. The operation of the system may otherwise be the same as described above.

Embodiments are also disclosed in which the customer's mobile device uses the transaction information obtained from the POS system to (1) register the customer's visit to the merchant's location with a social networking type system, and/or (2) communicate with a payment service to complete payment for the item or items involved in the transaction.

Neither this summary nor the following detailed description purports to define or limit the scope of protection. The scope of protection is defined by the claims.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of one embodiment of a mobile retail loyalty network including a native mobile loyalty application installed on a customer mobile device;

FIG. 2 is a block diagram illustrative of another embodiment of a mobile retail loyalty network including a web mobile loyalty application enabling the use of a customer device using a generic QR code reader and mobile web browser;

FIG. 3 is a flow diagram illustrating operational phases of a customer use of the mobile loyalty network, in accordance with an embodiment;

FIG. 4 is a diagram of an example of a paper bill with a QR code, encoding a loyalty code, printed on the bill, in accordance with an embodiment;

FIG. 5 is a diagram of an example of a paper receipt with a QR code, encoding a loyalty code, printed on the bill, in accordance with an embodiment;

FIG. 6 is a block diagram of POS Terminal presenting a static loyalty code data container, in accordance with an embodiment;

FIG. 7 is a flow diagram illustrating the second operational phase when using mobile loyalty application on customer device, in accordance with an embodiment;

FIG. 8 is a flow diagram illustrating the second operational phase when using a generic QR code reader and mobile web browser on customer device, in accordance with an embodiment;

FIG. 9 is a flow diagram illustrating the third operational phase when merchant has selected Bill and Receipt flow, in accordance with an embodiment;

FIG. 10 is a flow diagram illustrating the third operational phase when merchant has selected Receipt Only flow, in accordance with an embodiment;

FIG. 11 illustrates a screen display of a mobile loyalty application, in accordance with an embodiment;

FIG. 12 illustrates a screen display of a mobile loyalty application, in accordance with an embodiment; and

FIG. 13 is a sequence diagram showing, generally, the first embodiment of the mobile retail loyalty network.

### DETAILED DESCRIPTION OF THE PREFERRED EMBODIMENTS

A system will now be described that embodies various inventive features related to a customer loyalty network including communications between customer mobile devices, point-of-sale (POS) systems, and other servers and databases. As will be recognized, many of these features may be used independently of others, and represent distinct inventions. Further, many of the features may be implemented differently than described herein. Thus, nothing in this detailed description implies that any particular feature, component, process step, characteristic, of combination of the foregoing is essential.

Generally, some embodiments of the present disclosure relate to a customer loyalty network in which a mobile device of a customer, a POS system of a merchant selling goods or services, and a loyalty program server (“loyalty server”), interact. The loyalty server is typically operated by a Loyalty Program Service Provider that administers customer loyalty programs for various merchants, but may alternatively be operated by the merchant. Generally, the POS system generates a code image or “loyalty code,” which is printed on a receipt or bill for a transaction and/or displayed on a display screen of the POS terminal. The customer photographs or scans the loyalty code with their mobile device, which then transmits transaction information extracted from the loyalty code to the loyalty server. In some embodiments, the loyalty server then communicates with the POS system and the customer's mobile device, at which point the customer may redeem loyalty network points to reduce the cost of their bill or receive some other benefit.

The POS system is typically operated by a merchant of goods or services who is part of the customer loyalty network. When a good or service is rendered to a customer, typically either a bill or a receipt, or both, is generated by the POS system and provided to the customer. A POS loyalty application—which is typically provided by the Loyalty Program Service Provider—is integrated with the POS system so that when the bill or receipt is rendered, a loyalty code is included. (As mentioned below, a hardware device that augments the print stream may alternatively be used to add the code image to the bill or receipt, such that minimal or no software needs to be added to the POS system.) The loyalty code may be a QR code or other bar code that is printed directly on the bill or receipt. The bill or receipt may be printed on paper, and/or may be displayed on a customer-facing display screen. The scenario in which the QR code is printed on the bill is described first.

The customer mobile device, such as a cell phone or smartphone, is typically operated by a customer who is obtaining goods or services from the merchant. The customer mobile device includes a camera and a native mobile loyalty application that is provided by the Loyalty Program Service Provider. (As mentioned below, in some embodiments the customer can alternatively use a generic QR reader application and browser, without installing or using a mobile loyalty application.) If the customer is already part of the customer loyalty network they may log in to their account on the native mobile loyalty application directly. If the customer is not already part of the customer loyalty network they may join through an application or gateway (such as a web form) operated by the merchant, or directly though an application or gateway (such as a web form) operated by the Loyalty Program Service Provider. The customer mobile device is wirelessly connected to a WAN (wide area network) network, usually the internet. The customer or user of the mobile device obtains the bill that was generated by the POS system, and may use the native mobile loyalty application (or a generic QR reader) and camera to take a photograph or scan of the loyalty code. The loyalty code contains encoded information related to the transaction with the merchant The transaction information may, but need not be, encoded in the loyalty code in the form of a URI (Uniform Resource Identifier). The information obtained from the loyalty code, along with the customer loyalty network login information of the customer, is then transmitted wirelessly to the loyalty server.

The loyalty server is typically operated by the Loyalty Program Service Provider, and may be implemented by one or more physical servers or other computing devices programmed with executable code modules. The Loyalty Program Service Provider typically operates the customer loyalty network for many different merchants. The loyalty server includes a loyalty server database with account information for customers that are part of the customer loyalty network. Information concerning the transaction that the customer made with merchant and the customer loyalty network login information of the customer (which was transmitted by the customer's mobile device) is received by the loyalty server through the WAN network, usually the internet. The loyalty server communicates with the merchant's POS system to retrieve the billed item specific to the particular customer's transaction. The loyalty server then looks up the customer information in the database and determines the balance of the customer's loyalty program rewards with the merchant, or with a coalition loyalty program in which the merchant participates.

If the customer had redeemable customer loyalty rewards, the loyalty server transmits the information back to the mobile device, giving the customer the option of redeeming the rewards and applying the credit against the bill that was issued by the merchant The customer may choose to redeem all or part of the reward credit thorough the native mobile loyalty application, at which point the native mobile loyalty application transmits the redemption information back to the loyalty server. The loyalty server reduces the value of the customer's loyalty reward accordingly, and then transmits the redemption information (including the value of the redemption and the transaction information) to the POS system. The POS system then reduces the amount of the customer's bill accordingly, and the customer then pays the reduced bill. Finally, the value of the customer's transaction with the merchant is used by the loyalty server to increase the value of the customer's loyalty rewards credit (which may then be applied toward future transactions with the merchant).

In another implementation, the POS system prints a loyalty code as described above on a receipt for goods or services purchased by the customer. The customer then uses the mobile device running the native mobile loyalty application or a generic QR reader to take a picture of the loyalty code on the receipt. (The merchant may additionally or alternatively display the code on a customer-facing display screen of the POS terminal, in which case the customer may photograph the code as displayed on the display screen.) The information about the customer and the transaction is then transmitted to the loyalty server. The server then contacts the POS system and retrieves the value of the transaction. The value of the transaction is then used to increase the value of the customer's loyalty rewards credit (which may then be applied toward future transactions with the merchant).

Alternatively, the complete transaction information, including the value of the transaction (i.e., the total or subtotal of the cost of the transaction), may be encoded in the loyalty code printed on the receipt. In this implementation, the loyalty server does not contact the POS system to retrieve the value of the transaction. Also, in this implementation, the POS loyalty application integrated with the POS system may be a simplified version as compared to the version that is integrated in the bill implementation. This is because in this implementation the POS loyalty application prints loyalty codes, and typically need not communicate with the loyalty server.

In yet another implementation, a printout or other display of the loyalty code is affixed to the POS system or terminal, rather than being printed on a bill or receipt. In this implementation, the customer may take a picture of the affixed loyalty code, at which point the information about the POS system and the time that the picture was taken is transmitted to the loyalty server (in a manner similar to that described above). The loyalty server then contacts the POS system to retrieve information about the value of the transaction (as described above). The value of the transaction is then used to increase the value of the customer's loyalty rewards credit (which may then be applied toward future transactions with the merchant).

As mentioned above, the system may also support the ability for customers to use a generic QR code reader and a web browser, rather than downloading a special loyalty program application such as a native mobile loyalty application. In such use case scenarios, when the loyalty code (such as a QR code) is presented to the customer (whether it is on a bill, receipt, or affixed to a POS system) the customer takes a picture of the QR code and the loyalty code information is extracted by the generic QR code reader. The extracted loyalty code information includes a URI (Uniform Resource Identifier), which may be in the form of a URL (Uniform Resource Locator) such as a world wide web address. The URI is used by the generic QR code reader to navigate the web browser of the mobile device to that URI. The URI directs the browser to a web mobile loyalty application that is operated by the Loyalty Program Service Provider, which is in communication with the loyalty server. The information concerning the transaction is then transmitted to the web mobile loyalty application, and then to the loyalty server. As described above, the transaction information will then be used to contact the POS system and eventually to allow the customer to redeem loyalty rewards credits.

In some implementations, the customer may choose to redeem their accumulated merchant loyalty rewards credits in the form of a check or gift card or voucher for goods or services that is mailed directly to the customer or is fulfilled by the merchant at the merchant's place of business. The mailing of a check or gift card may alternatively be initiated automatically when a predetermined credit threshold is reached. Alternatively, rewards may be redeemed automatically when the customer engages in a transaction with the merchant, based on predetermined redemption rules.

In some embodiments, when a merchant enrolls with the loyalty program service provider, the merchant may choose between various implementation options, and may configure its POS system or systems accordingly. For example, the merchant may configure its POS system(s) differently depending upon whether the loyalty code will be printed on a bill, printed on a receipt, affixed at POS terminals, or a combination thereof

The system will next be described in greater detail. Although aspects of the system will be described according to the drawings, flow diagrams, and specific examples, one skilled in the relevant art will appreciate that the disclosed embodiments are illustrative in nature. Accordingly, the disclosed embodiments should not be construed as limiting.

### FIRST EMBODIMENT-MOBILE RETAIL LOYALTY NETWORK 100

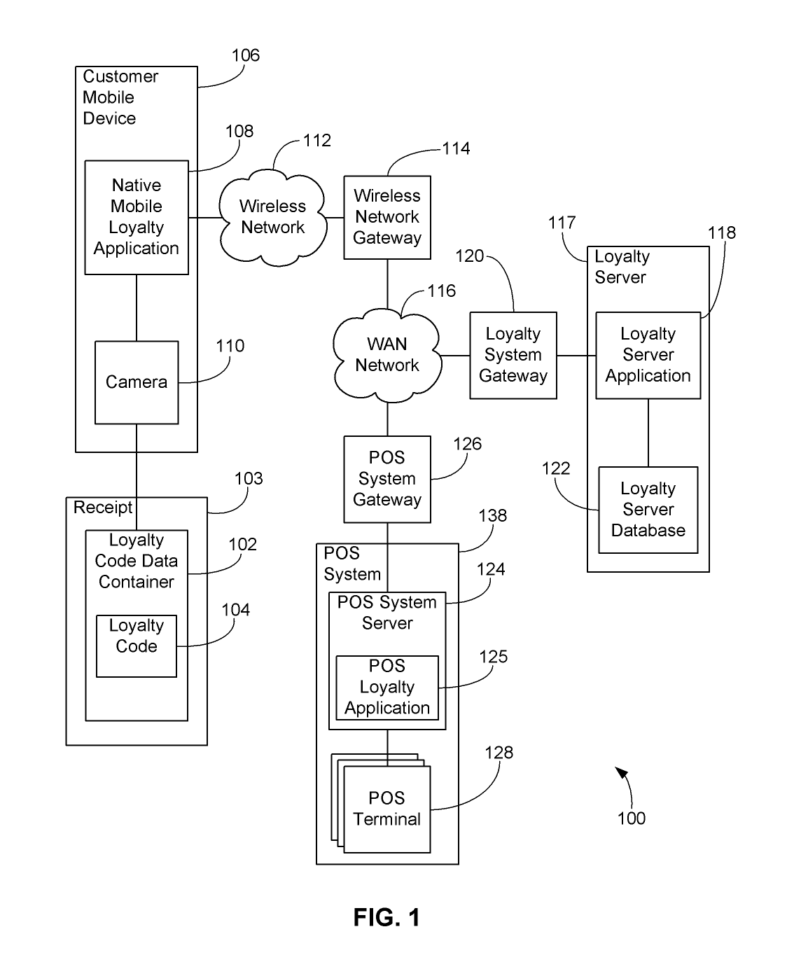

FIG. 1 shows a block diagram of a first embodiment of a Mobile Retail Loyalty Network 100. In this first embodiment, a loyalty code 104 is printed on a receipt 103 that is scanned and processed using native mobile loyalty application 108 that runs on a customer's mobile device 106. In this embodiment, although receipt 103 is shown in FIG. 1, loyalty code 104 may alternatively be printed on a bill or affixed to a POS terminal (as will be explained below). The Mobile Retail Loyalty Network 100 includes a wireless network 112, a wireless network gateway 114, a WAN (wide area network) network 116, a POS (Point-of-Sale) system gateway 126, a POS system 138, a loyalty system gateway 120, and a loyalty server 117. The loyalty server 117 includes a loyalty server application 118 and a loyalty server database 122. As illustrated, each receipt 103 printed by the POS system 138 includes a loyalty code data container 102 which includes a loyalty code 104. The POS system server 124 includes a POS Loyalty Application 125.

Typically, the POS system 138 is operated by a merchant, the customer mobile device 106 is operated by a customer of the merchant, and the loyalty server 117 is operated by a Loyalty Program Service Provider. The customer mobile device 106 communicates with the wireless network 112, which wireless network 112 communicates with the WAN network 116 through wireless network gateway 114. Similarly, the loyalty server 117 communicates with the loyalty system gateway 120, and the loyalty system gateway 120 communicates with the WAN network 116. Similarly, again, the POS system 138 communicates with the POS system gateway 126, and the POS system gateway 126 communicates with the WAN network 116.

After completing a transaction with the merchant, the customer may photograph/scan the loyalty code data container 102 portion of the receipt 103 using the native mobile loyalty application 108 and the mobile device's built-in camera 110. The customer may perform this step at the merchant's store, or after leaving the store (e.g., several hours or days later). The loyalty code 104 data is then communicated to the native mobile loyalty application 108, and subsequently may be communicated through the wireless network 112 and WAN network 116 to the loyalty server 117. The Loyalty Program Service Provider, who usually operates the loyalty server 117, typically manages customer loyalty programs for many different merchants on the loyalty server 117.

In general, information related to the customer's transaction with the merchant is encoded by the POS system 138 in the loyalty code 104 printed/encoded on the receipt 103. When the loyalty code data container 102 is scanned or photographed by the customer and communicated to the loyalty server 117, the transaction information is extracted from the loyalty code 104. The native mobile loyalty application 108 may then communicate with the loyalty server 117 and the POS system 138 to allow the customer to log in to their account, or create a new account, with the Loyalty Program Service Provider or the merchant The customer's account information, including loyalty network points, may also be retrieved from the loyalty server 117 and displayed by the native mobile loyalty application 108. Redemption of loyalty network points may be made by the customer through native mobile loyalty application 108, as will be explained in detail below. Loyalty network points may also be added to the customer's account on the loyalty server 117.

Typically, an existing merchant with an existing POS system joins Mobile Retail Loyalty Network 100 and then configures its existing POS system 138 (or each such system) by installing the POS Loyalty Application 125 on an existing POS system server 124. Subsequently, the existing POS system 138, having had the POS Loyalty Application 125 added on, may communicate with the loyalty server 117 and with the mobile devices 106 of customers, and may produce receipts 102 as described above. The addition of the POS Loyalty Application 125 also gives the user of the POS Terminal 128 a real-time view of the status of the rewards redemption, and allows the loyalty server 117 to communicate with the POS system 138 in real-time. In this way, a merchant with an existing POS system may easily integrate a real-time rewards program with their system. Alternatively, the merchant may join the Mobile Retail Loyalty Network 100 through an automated process in which they sign up for the network through the Loyalty Program Service Provider's website, and the POS Loyalty Application 125 is automatically installed on the existing POS system. The POS Loyalty Application 125 may alternatively be installed as a separate component of the POS system 138, such as a communications device or printer between the POS system gateway 126 and the POS system server 124, or in communication with the POS System Server. The POS System Server 138 may, in some cases, include multiple physical servers or other computing devices that interact over a network.

Loyalty Code Data

The receipt 103 (for example, a paper receipt) has printed on it a loyalty code data container 102. In the first embodiment, the loyalty code data container 102 is a QR code. Alternatively, loyalty code data container 102 may be a 1-D barcode, other form of 2-D barcode such as DataMatrix, ShotCode, High Capacity Color Barcode or Microsoft Tag, or another type of machine-readable code. QR codes are 2-dimensional barcodes that may be scanned and read by mobile devices with the appropriate software installed. Loyalty code data container 102 has encoded, according to the standard encoding rules for QR Codes, a loyalty code 104. Loyalty code 104 is a string of alphanumeric data that, in the first embodiment, is preferably in the form of a Uniform Resource Identifier (URI), more commonly recognized by lay users as a web address. This string of alphanumeric data includes, in the first embodiment, the point-of-sale system identifier (POS_SYSTEM_ID), point-of-sale terminal identifier (POS_TERMINAL_ID), point-of-sale transaction identifier (POS_TRANSACTION_ID) and point-of-sale terminal timestamp (POS_TERMINAL_TIME). The receipt 103 may alternatively be a display, such as an LCD, TFT, or CRT display on a computer, cell-phone, tablet computer, smartphone, or some other computerized device.

The use of a URI format for the loyalty code 104 is not essential, but is useful for supporting mobile devices 106 that do not (or do not yet) have the native mobile loyalty application 108 installed thereon. Specifically, as described below, this format enables a customer to scan the receipt 102 using a generic QR or other reader application, and to then access the loyalty server 117 using a web browser.

The following sections provide details of specific encoding formats, service interfaces, and communication protocols that may be used to implement the above-described functionality. As will be apparent, these details can be varied widely, and are not essential to the invention.

Loyalty Code 104 Encoding

Loyalty code data container 102 includes a data payload—the transaction information—including loyalty code 104. Loyalty code 104 incorporates the web domain name of the loyalty system server or servers (LOYALTY_SYSTEM_DOMAIN), and is encoded as follows:

loyalty code 104=“https://LOYALTY_SYSTEM_DOMAIN/landing/<RECEIPT_CODE>”

where the receipt code string (RECEIPT_CODE) is formed as follows: RECEIPT_CODE=URLENCODE(CONCATENATE(POS_SYSTEM_ID, “,”, POS_TERMINAL_ID, “,” POS_TRANSACTION_ID, “,” POS_TERMINAL_TIME, “,”))

Loyalty Code Encoding Example:

Given:

LOYALTY_SYSTEM_DOMAIN=example-loyalty-domain.com POS_SYSTEM_ID=city-coffee-shop POS_TERMINAL _ID=0124 POS_TRANSACTION ID=0010230 POS_TERMINAL₁₃ TIME=2010-04-02T09:57Z

Then the RECEIPT_CODE is formed as follows: URLENCODE(“city-coffee-shop,0124,0010230,2010-04-02T09:57Z”)

which after URL encoding is translated to: city-coffee-shop % 2C0124% 2C0010230% 2C2010-04-02T09% 3A57Z

giving a final loyalty code 104 string: loyalty code 104=“https://example-loyalty-domain.com/landing/city-coffee-shop% 2C0124%2C0010230%2C2010-04-02T09%3A57Z”

This loyalty code 104 is then supplied to a QR code encoding function, which encodes the loyalty code 104 (the payload data) into the loyalty code data container 102, in this case, a printable QR code.

Customer Mobile Device

The customer mobile device 106 may be a cell phone, smartphone, tablet computer, PDA, or other mobile communications device capable of sending and receiving data over a wireless network. In the first embodiment, the customer mobile device 106 has the native mobile loyalty application 108 installed thereon. Native mobile loyalty application 108, in the first embodiment, operates on a mobile software platform such as iPhone OS, Android OS, Palm WebOS, J2ME, Windows Mobile, Flash, Flash Mobile, or other similar mobile software platform. Customer mobile device 106 also includes an acquisition device capable of capturing the loyalty code data container 102 for decoding. In the first embodiment, this acquisition device is the camera 110 that may be controlled by software installed on the mobile device. Native mobile loyalty application 108 has the capability to control camera 110 such that images or video may be captured with camera 110 and provided in digital form to native mobile loyalty application 108. The captured images or video are then provided to standard QR Code decoding software embedded in or linked to native mobile loyalty application 108.

Mobile Device Data Connectivity

Customer mobile device 106 is connected to a wireless network 112, such as a commercial cellular data network. Wireless network 112 has a wireless network gateway 114 providing access to a WAN network 116 that, in the first embodiment, is the global Internet. Hence customer mobile device 106 has data communications access to WAN network 116 and to network devices with data communications access to WAN network 116. Wireless network 112 may alternatively be a cellular radio access network, a wireless network based on the family of IEEE 802.11 technical standards (“WiFi”), a wireless network based on IEEE 802.16 standards (“WiMax), and other wireless networks. WAN network 116, also, may alternatively be a cellular radio access network, a wireless network based on the family of IEEE 802.11 technical standards (”WiFi“), a wireless network based on IEEE 802.16 standards (”WiMax), or other wireless network. The operation of communication networks, such as wireless network 112 and WAN network 116 are well known and will not be described in greater detail.

Loyalty Server Application Connectivity

The loyalty server application 118 is connected to the loyalty system gateway 120. Loyalty system gateway 120 is connected to WAN network 116. Hence loyalty server application 118 has data communications access to WAN network 116 and to network devices with data communications access to WAN network 116. Also, loyalty server application 118 is connected to the loyalty server database 122 that stores customer records, customer reward redemption transaction records, customer reward earnings transaction records, and POS_System Server registration records. In the first embodiment, these record types include the following information. Customer records include customer username (USERNAME), password (SHA1_PASSWORD), and customer reward balance information. Reward redemption transaction records include customer id, POS system id (POS_SYSTEM ID), transaction time (POS_TERMINAL₁₃ TIME), unique transaction id (POS_TRANSACTION_ID), redeemed item (ITEM_LIST), and redeemed value information. Reward earnings transaction records include customer id, POS system id (POS_SYSTEM_ID), transaction time (POS_TERMINAL₁₃ TIME), unique transaction id (POS_TRANSACTION_ID), paid value, and earned value information. POS System Server registration records include, in the first embodiment, a POS_SYSTEM_ID, Hostname and IP Address.

Loyalty Server Application

In one embodiment, the loyalty server application 118 exposes the following web service interface methods:

1. Acquire(USER, POS_SYSTEM_ID, POS_TERMINAL_ID, POS_TRANSACTION_ID, POS_TERMINAL₁₃ TIME) 2. Redeem(USER, LOYALTY_TRANSACTION_ID, ITEM_LIST) 3. TransactionClosed(POS_SYSTEM_ID, POS_TERMINAL _ID, POS_TRANSACTION_ID, POS_TERMINAL₁₃ TIME) 4. CreateCustomer(USERNAME, SHA1_PASSWORD) 5. AuthenticateCustomer(USERNAME, SHA1_PASSWORD)

The Acquire( )interface is usually called by the customer mobile device 106. Transaction and user information are supplied to the loyalty server 117, and the loyalty server 117 typically responds to the customer mobile device 106 with the details of the transaction information as reported by the POS_system 138. The Redeem( ) interface is usually called by the customer mobile device 106, and communicates to the loyalty server 117 the customer's decision to redeem loyalty points. The TransactionClosed( ) interface is usually called by the POS_system 138, and communicates to the loyalty server 117 that the transaction is closed, and the details of that specific transaction. The CreateCustomer( ) interface is usually called by the customer mobile device 106, and is used to create a new customer account in the loyalty server database 122. The AuthenticateCustomer( ) interface is usually called by the customer mobile device 106, and is used to authenticate the customer and the customer's association with a particular customer account. Additional details of these interfaces will be given below.

All web service method calls are preferably secured by a TLS connection, or some other type of encrypted, secured, or authenticated connection.

POS System Connectivity

The POS system server 124 is part of the POS system 138, and is connected to the POS system gateway 126. The POS system gateway 126 is connected to WAN network 116. Hence, the POS system server 124 has data communications access to WAN network 116 and to network devices with data communications access to WAN network 116. POS system server 124 is also connected to POS terminals 128 that are typically co-located with POS system server 124 within the same building. Both the POS system server 124 and the POS terminals 128 are part of the POS system 138.

POS System Gateway

In the first embodiment the POS system gateway 126 exposes the following service interface methods:

GetTxnInfo1(POS_TERMINAL_ID, POS_TRANSACTION_ID) UpdateTxnInfo1(POS_TERMINAL_ID, POS_TRANSACTION_ID)

The POS system gateway 126 may expose the following service interfaces instead of, or in addition to, GetTxnInfo1 and UpdateTxnInfo1:

GetTxnInfo2 (POS_TERMINAL_ID, POS_TERMINAL₁₃ TIME) UpdateTxnInfo2 (POS_TERMINAL_ID, POS_TERMINAL₁₃ TIME)

The GetTxnInfo1( ) (and GetTxnInfo2( ) interface is usually called by the loyalty server 117, and the POS_system 138 responds to the call with transaction details. The UpdateTxnInfo1( ) (and UpdateTxnInfo2( ) interface is usually called by the loyalty server 117, and is used to update transaction information when the customer has decided to redeem loyalty points to reduce the cost of the transaction. Additional details of these interfaces will be given below.

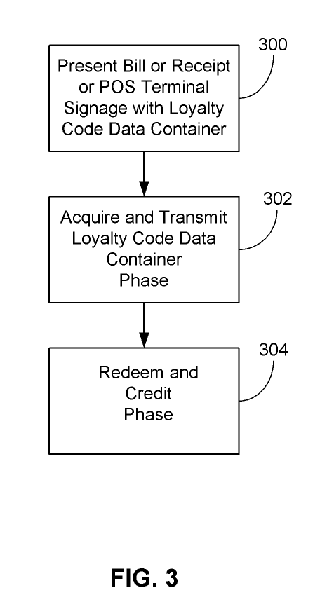

Turning now to FIG. 3, FIG. 3 shows a flow diagram illustrating the operational phases of the Mobile Retail Loyalty Network 100 (of FIG. 1). There are three operational phases: in phase 300, the loyalty code data container 102 (of FIG. 1) is generated and presented to the customer either on a bill or receipt, or affixed to a POS system or terminal; in phase 302, the loyalty code 104 (of FIG. 1) data is captured by the customer utilizing the customer mobile device 106, or some other capable device; in phase 304, communications take place between the customer mobile device 106, POS system 138, and loyalty server 117 (all of FIG. 1) to redeem points, credit points toward the transaction, and add points to the customer's account, among other communications.

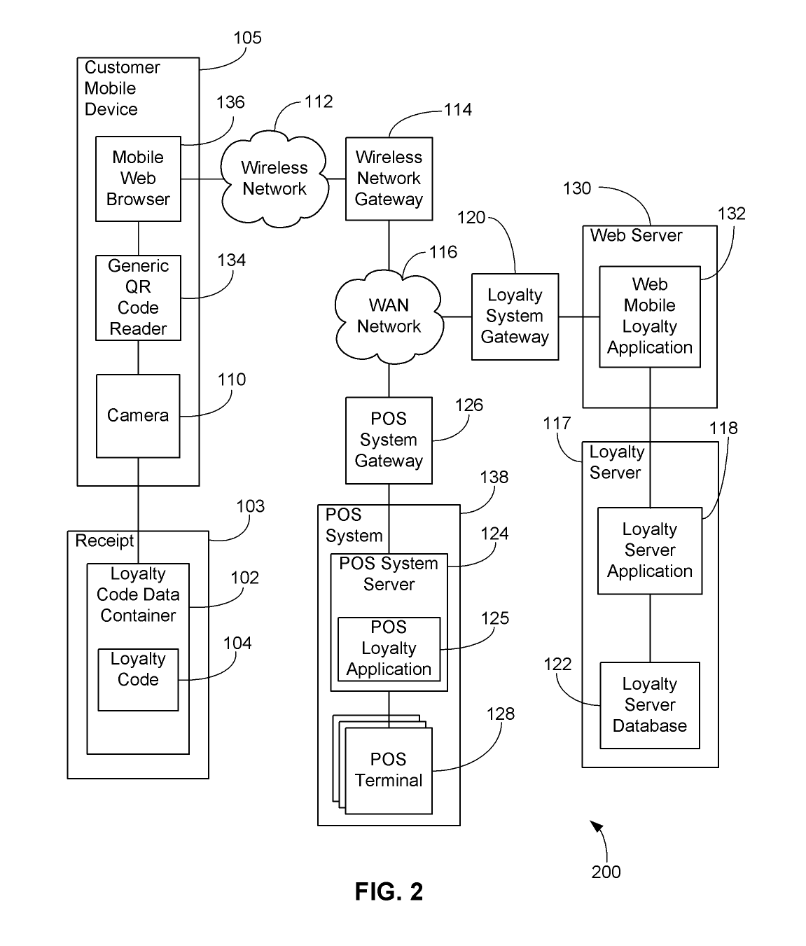

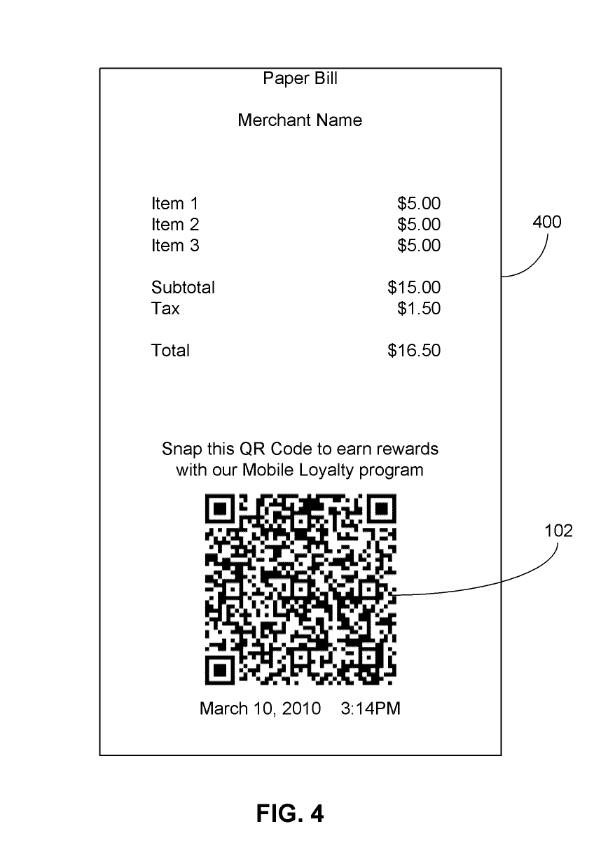

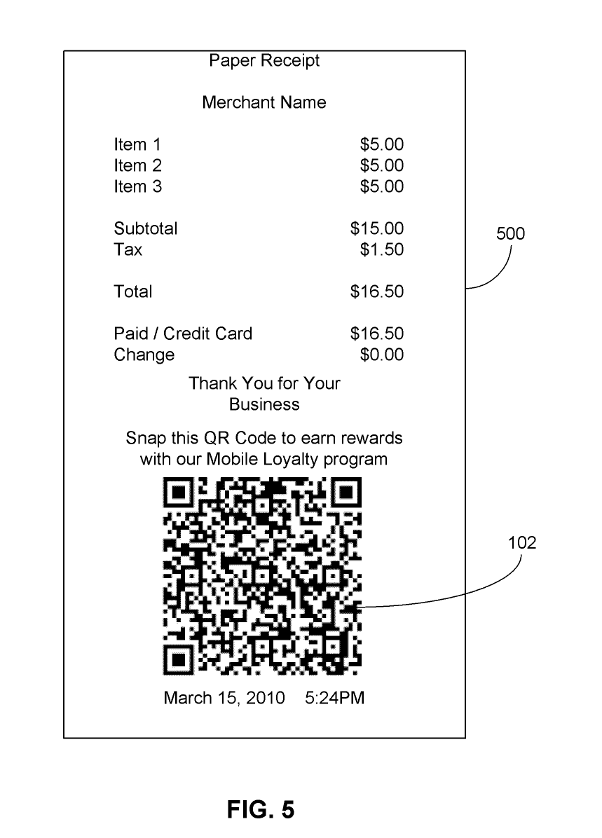

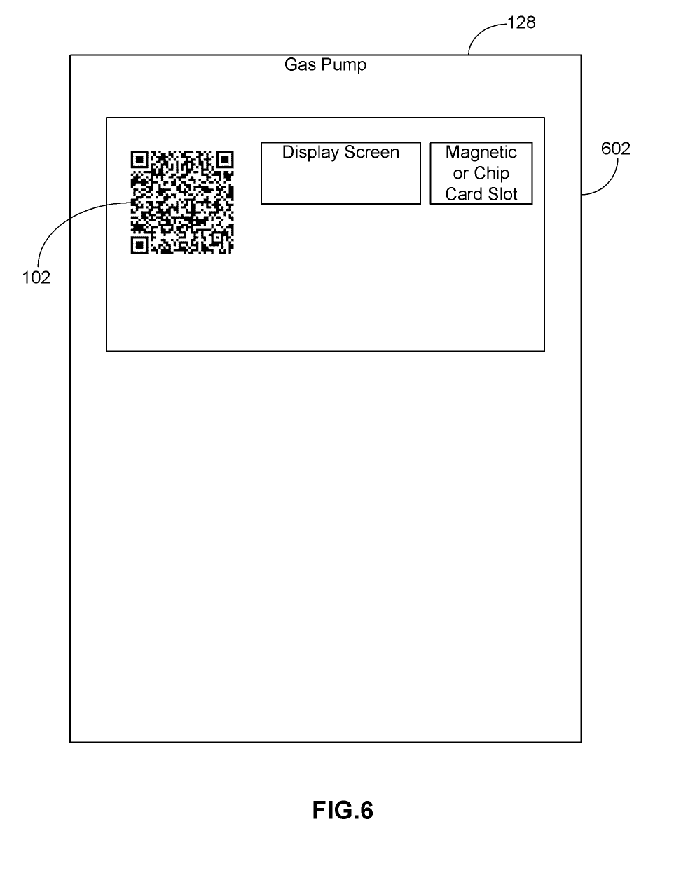

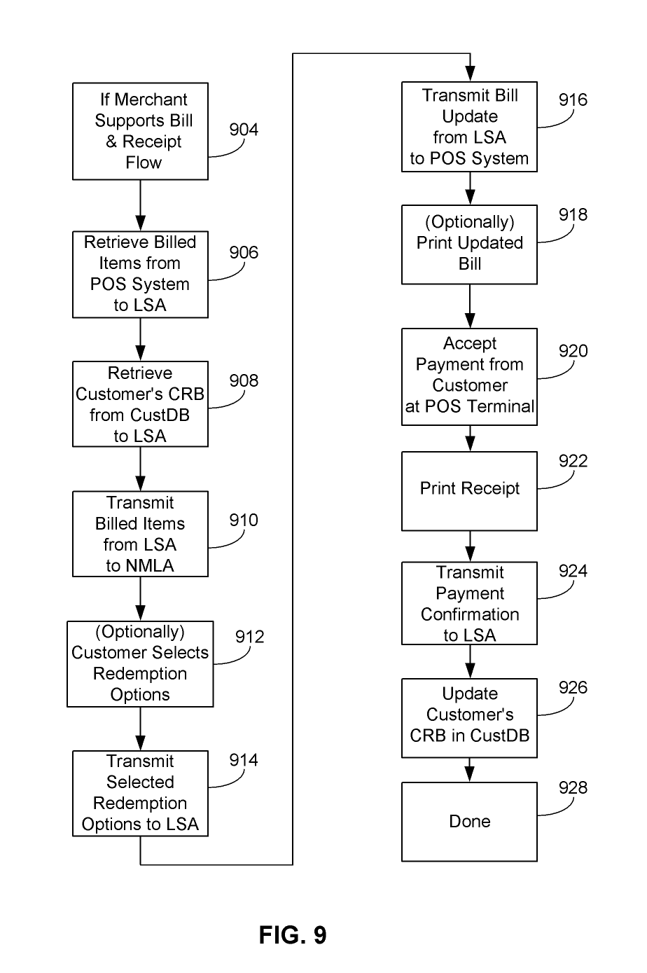

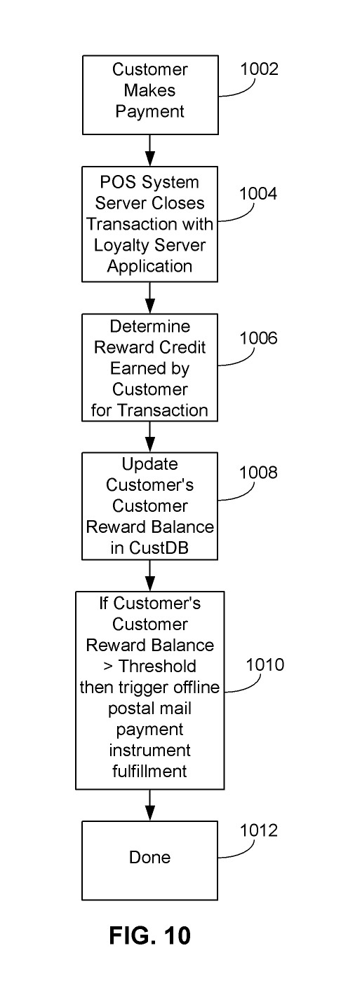

In more detail, the first operational phase 300, in the first embodiment, includes printing and presenting a Paper Bill 400 as shown in FIG. 4, a Paper Receipt 500 shown in FIG. 5, or a loyalty code 104 affixed to the POS Terminal 128 shown in FIG. 6, to the customer. Paper Bill 400 and Paper Receipt 500 correspond to receipt 103 of FIGS. 1 and 2. The second operational phase 302, in the first embodiment, includes using native mobile loyalty application 108 to scan and read the loyalty code data container 102 and to decode loyalty code data container 102 to extract loyalty code 104, authenticating the user when desirable, and transmitting the user credentials and the decoded loyalty code 104 from native mobile loyalty application 108 to the loyalty server application 118 through the WAN network 116. The third operational phase 304, in the first embodiment, includes the processing steps of FIG. 9 or FIG. 10. The processing steps of FIG. 9 are used if Paper Bill 400 of FIG. 4 has been presented in first operational phase 300. The processing steps of FIG. 10 are used if Paper Receipt 500 of FIG. 5 has been presented in first operational phase 300.

FIRST OPERATIONAL PHASE 300 OF THE FIRST EMBODIMENT-PRESENTATION OF LOYALTY CODE DATA CONTAINER 102

Variant 1: Presentation of QR Code on Paper Bill 400

Upon a request by a member of the merchant's staff to print a bill for the transaction prior to customer payment, POS Terminal 128, in the first embodiment, retrieves from POS system 138 configuration storage the LOYALTY_SYSTEM_DOMAIN, POS_SYSTEM_ID, and POS_TERMINAL _ID.

POS_Terminal 128 configuration data example: LOYALTY_SYSTEM_DOMAIN=example-loyalty-domain.com POS_SYSTEM_ID=city-coffee-shop POS_TERMINAL _ID=0124

Also, POS Terminal 128 retrieves the transaction id for the in-progress transaction:

POS_TRANSACTION_ID=0010230

Also, POS_Terminal 128 retrieves the current time:

POS_TERMINAL₁₃ TIME=2010-04-02T09:57Z

POS terminal 128 then forms loyalty code 104 as described in loyalty code 104 Encoding previously. Using standard techniques of QR Code generation, a QR Code image (loyalty code data container 102) containing loyalty code 104 is generated by the POS terminal 128.

Paper Bill 400 of FIG. 4 is printed, with QR Code image (loyalty code data container 102) printed on the Paper Bill 400, which is presented to the customer prior to payment. This variant of the first operational phase 300 supports, in the third operational phase 304, the redemption of a customer's reward balance to pay for all or part of the charged amount of Paper Bill 400 of FIG. 4, and the crediting of the customer's reward credit balance after payment has been made for the balance of the bill that was paid for by cash, credit card or other means not including reward balance redemption. Also supported is optional subsequent triggering of an offline credit fulfillment process. Such an offline credit fulfillment process may include a mailed redeemable merchant-branded (or unbranded) gift card, which may optionally be rechargeable upon additional future credit fulfillments.

Variant 2: Presentation of QR Code on Paper Receipt 500

Upon a request by a member of the merchant's staff to print a receipt for the transaction after the customer has provided payment, POS Terminal 128 in the first embodiment retrieves from system configuration storage the LOYALTY_SYSTEM_DOMAIN, POS_SYSTEM_ID, and POS_TERMINAL _ID.

POS_Terminal 128 configuration data example: LOYALTY_SYSTEM_DOMAIN=example-loyalty-domain.com POS_SYSTEM ID=city-coffee-shop POS_TERMINAL _ID=0124

Also, POS Terminal 128 retrieves the transaction id for the in-progress transaction:

POS_TRANSACTION_ID=0010230

Also, POS Terminal 128 retrieves the current POS terminal time: POS_TERMINAL₁₃ TIME=2010-04-02T09:57Z PO

terminal 128 then forms loyalty code 104 as described in loyalty code 104 Encoding previously. Using standard techniques of QR Code generation, a QR Code image (loyalty code data container 102) containing loyalty code 104 is generated by the POS Terminal 128.

Alternatively, the complete transaction information, including the value of the transaction (i.e., the total or subtotal of the value of the transaction), may be encoded in the loyalty code 104 printed on the paper receipt 500.

Paper Receipt 500 of FIG. 5 is printed, with QR Code image (loyalty code data container 102) printed on the Paper Receipt 500, and presented to the customer after the customer has provided payment successfully to the merchant This variant of the first operational phase 300 supports, in the third operational phase 304, crediting of the customer reward balance for a customer, and the optional subsequent triggering of an offline credit fulfillment process. Such an offline credit fulfillment process may include a mailed redeemable merchant-branded (or unbranded) gift card, which may optionally be rechargeable upon additional future credit fulfillments.

Variant 3: Presentation of QR Code (Loyalty Code Data Container 102) on POS Terminal 128

POS Terminal 128 of FIG. 6 with QR code (loyalty code data container 102) displayed or affixed in a prominent area presents a prompt to the user to acquire QR Code (loyalty code data container 102) with their mobile device. In this variant, FIG. 6 includes the exemplary gas pump 602, and the built-in POS Terminal 128 with signage displaying loyalty code data container 102. In the first embodiment, QR Code (loyalty code data container 102) is displayed via a printed sticker or panel affixed to POS Terminal 128 near the payment interaction display or card reader.

QR Code (loyalty code data container 102) in this variant encodes the LOYALTY_SYSTEM_DOMAIN, POS_SYSTEM_ID, and POS_TERMINAL_ID, without including POS_TRANSACTION_ID and POS_TERMINAL_TIME.

POS Terminal 128 QR Code (loyalty code data container 102) encoded data example: LOYALTY_SYSTEM_DOMAIN=example-loyalty-domain.com POS_SYSTEM ID=city-coffee-shop POS_TERMINAL _ID=0124

Variant 3 Loyalty Code Encoding Example:

Given: LOYALTY_SYSTEM_DOMAIN=example-loyalty-domain.com POS_SYSTEM_ID=city-coffee-shop POS_TERMINAL _ID=0124

Then the RECEIPT_CODE is formed as follows: URLENCODE(“city-coffee-shop,0124”)

which after URL encoding is translated to: city-coffee-shop%2C0124

giving a final loyalty code 104 string: loyalty code 104=“https://example-loyalty-domain.com/landing/city-coffee-shop%2C0124”

This loyalty code 104 is encoded by a QR Code (loyalty code data container 102) encoding function as the QR Code (loyalty code data container 102) payload data. The resulting QR Code (loyalty code data container 102) image is printed for use as a sticker and affixed to the POS Terminal 128.

As an example, in this variant POS Terminal 128 may be embedded in a gasoline pump 602 at a gas station as depicted in FIG. 6. This variant allows for loyalty system support for a POS Terminal 128 that (a) prints receipts, not bills, and (b) does not have sufficient screen display capabilities to dynamically render a QR Code, and (c) does not support a multiple transaction flow.

This above variant of the first operational phase may still support the crediting of loyalty credit since LOYALTY_SYSTEM_DOMAIN, POS_SYSTEM_ID, and POS_TERMINAL _ID are provided in loyalty code 104, and knowing these details in combination with (a) the time of QR code (loyalty code data container 102) acquisition by the customer using customer mobile device 106 on its own or in combination with (b) partial digits of the customer's previously used credit card or payment card, allows for contact with the POS system 138 as in other variants of the first operational phase 300 and to discover the transaction id via the acquisition time, since in this variant POS Terminal 128 does not support a multiple transaction flow, as previously stated.

This variant of the first operational phase 300 supports, in the third operational phase 304, the redemption of a customer's reward balance to pay for all or part of the charged amount displayed at POS Terminal 128 of FIG. 6, and the crediting of the customer's reward credit balance after payment has been made for the remaining balance of the bill not paid for through customer reward balance redemption. Also supported is optional subsequent triggering of an offline credit fulfillment process. Such an offline credit fulfillment process may include a mailed redeemable merchant-branded (or unbranded) gift card, which may optionally be rechargeable upon additional future credit fulfillments.

SECOND OPERATIONAL PHASE 302 OF THE FIRST EMBODIMENT-ACQUIRE LOYALTY CODE DATA CONTAINER 102 AND TRANSMIT

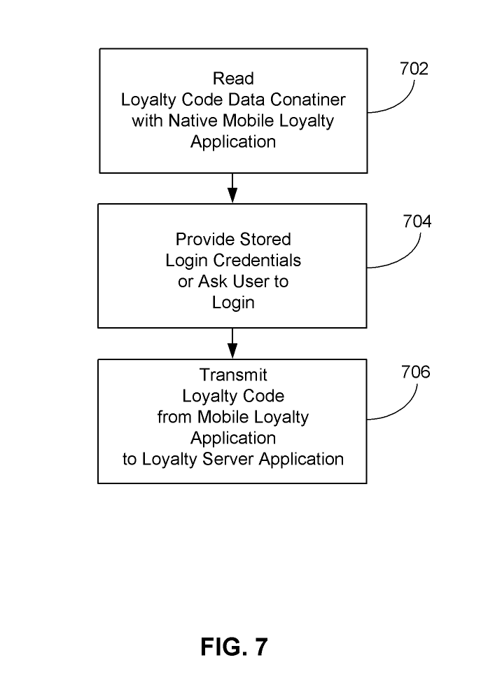

FIG. 7 shows a flow diagram of the second operational phase 302, when the loyalty code 104 is acquired and transmitted using the native mobile loyalty application 108. The second operational phase 302, in the first embodiment, includes the customer using native mobile loyalty application 108 to scan and read loyalty code data container 102 (a QR Code in this embodiment) (in step 702); decoding loyalty code data container 102 to extract loyalty code 104 (in step 702); collecting the customer's user credentials from the customer via a login prompt or via retrieval, from local persistent storage, of user credentials previously provided (in step 704); and transmitting the user credentials and decoded loyalty code 104 from native mobile loyalty application 108 to the loyalty server application 118 through the WAN network 116 (in step 706).

In step 702, the scanning and reading of QR Code (loyalty code data container 102) is accomplished through well-known standard techniques of image or video capture and QR code recognition, standardized in ISO/IEC 18004:2006. Having decoded QR

Code (loyalty code data container 102), the payload loyalty code 104 is known. Loyalty code 104 is then processed as follows by native mobile loyalty application 108:

1. De-URL Encode the payload string, resulting in: https://example-loyalty-domain.com/landing/city-coffee-shop,0124,0010230,2010-04-02T09:57Z

2. Strip the leading characters up to the last “/” character, resulting in: city-coffee-shop,0124,0010230,2010-04-02T09:57Z

3. Splits the string on the “,” character, resulting in the recovery of the original data components embedded in loyalty code 104: LOYALTY_SYSTEM_DOMAIN=example-loyalty-domain.com POS_SYSTEM_ID=city-coffee-shop POS_TERMINAL_ID=0124 POS_TRANSACTION ID=0010230 POS_TERMINAL₁₃ TIME=2010-04-02T09:57Z

In step 704, native mobile loyalty application 108 now collects the customer's user credentials via a login prompt, or from local persistent storage via retrieval of user credentials previously provided by the customer. (The details of this account login/creation process is covered below.)

In step 706, native mobile loyalty application 108 now initiates a web services call to the Acquire( )web service method of loyalty server application 118:

Acquire(USER, POS_SYSTEM_ID, POS_TERMINAL_ID, POS_TRANSACTION_ID, POS_TERMINAL₁₃ TIME)

The user authentication credentials for this web services call are provided via standard HTTP Authentication using the Digest Access Authentication Scheme as described in RFC 2617 (Internet Engineering Task Force, Network Working Group, Request for Comments: 2617). The authentication credentials identify the customer to loyalty server application 118.

THIRD OPERATIONAL PHASE 304 OF THE FIRST EMBODIMENT-REDEEM AND CREDIT

FIG. 9 shows a flow diagram of the third operational phase 304, when the merchant has selected bill and receipt flow (in other words, the POS system 138 supports providing the customer with either a bill or a receipt). In step 904, if the merchant supports bill and receipt flow, the flow continues to step 906. In step 906, upon receiving an Acquire( ) service request from, in the first embodiment, native mobile loyalty application 108, loyalty server application 118 looks up the provided POS_SYSTEM_ID in the POS System's database and retrieves the hostname or IP address of the corresponding POS system server 124. Loyalty server application 118 then sends a web services request to POS system server 124:

GetTxnInfo1(POS_TERMINAL_ID, POS_TRANSACTION_ID)

Since the Mobile Retail Loyalty Network 100 supports simultaneous connection and transaction processing with many POS Systems at once, provided by different POS System vendors, the following description of POS system server 124 processing of GetTxnInfo1( ) is an example.

POS System Server 124 Processing of GetTxnInfo1( )

POS system server 124 retrieves from internal state the in-progress transaction data object corresponding to the provided POS_TRANSACTION_ID. This transaction includes, in the first embodiment:

1. A list of product and service items, each including a SKU, item name, item quantity, and item price.

2. A subtotal

3. A list of tax items, each including a tax name, tax rate as percentage and tax amount charged

4. A total charged value for the transaction

Continuing within step 906, POS system server 124 serializes the transaction details. The serialized data is then, in the first embodiment, encoded in XML, or alternatively in JSON or other structured data format. This serialization is returned as the body of the response to the GetTxnInfo1( ) web services call.

Example GetTxnInfo1( ) web service response data:

```
<transaction>
  <item type=“food-appetizer”>
    <name></name>
    <value>10.00</value>
  </item>
  <item type=“food-main”>
    <name></name>
    <value>10.00</value>
  </item>
  <item type=“drink”>
    <name></name>
    <value>10.00</value>
  </item>
  <item type=“alcohol”>
    <name></name>
    <value>8.00</value>
  </item>
  <subtotal currency=“CAD”>48.00</subtotal>
  <total currency=“CAD”>50.45</total>
</transaction>
```

In step 908, loyalty server application 118, having received a response to the GetTxnInfo1( )call, then retrieves the customer's Customer Reward Balance (CUST_REWARD_BALANCE) from Customer Database of loyalty server database 122.

Reward Redemption Eligibility Check

Continuing with step 908, loyalty server application 118 then performs a Reward Redemption Eligibility Check. The Reward Redemption Eligibility Check determines a set of redemption options to be provided to the customer. The Reward Redemption Eligibility Check may be driven by static rules or configurable rules provided by the merchant In the first embodiment, the Reward Redemption Eligibility Check performs the following processing using the total value of the bill (BILL_TOTAL):

If CUST_REWARD_BALANCE >BILL_TOTAL (in other word, if the customer's reward balance is greater than the total value of the bill), then respond to the Acquire( )request with the following response body:

```
  <response>
    <redemption-option>
      <prompt>Would you like to redeem $50.45 of your reward
balance and get this meal for free?</prompt>
      <item>Total</item>
    </redemption-option>
  </response>
```

Alternatively, the Reward Redemption Eligibility Check may check whether the customer's reward balance is greater than a portion of the bill, or greater than the value of particular items on the bill. In this case, the loyalty server application 118 would respond to the Acquire( )request with a prompt to the customer, asking them if they would like to redeem a portion or all of the reward balance against the total value of the bill, or redeem a portion or all of the reward balance against the value of a particular item from the bill. As another alternative, the Reward Redemption Eligibility Check may prompt the customer to redeem rewards that give the customer a percent discount on the bill, or free items. The rewards available to the customer may include coupons for discounts on the bill, or other merchant determined rewards. Alternatively, the redemption of points against the value of the bill, reward coupons with the merchant, or other special promotions may be automatically redeemed during the Reward Redemption Eligibility Check based on predetermined rules set by the merchant, the customer, or the loyalty program.

In step 910, the response to the Acquire( ) request, including the customer prompt, is actually transmitted to the native mobile loyalty application 108. The loyalty server application 118 will then wait for a Redeem( ) request from the native mobile loyalty application 108.

Redemption Option Selection

In step 912, the native mobile loyalty application 108, having received the Acquire( ) response including one or more redemption-option elements, provides a visual prompt to the customer, in the first embodiment, as a dialog popup presenting the prompt text with a “Redeem” button response option and a “No Thanks” button response option.

If the customer selects the “No Thanks” option, the redemption portion of the Third Operational Phase 304 is complete. If the customer selects the “Redeem” option, then native mobile loyalty application 108 makes a Redeem( )web services call to loyalty server application 118.

Step 912 is optional, and the customer may choose not to redeem rewards. Alternatively, the merchant may give the customer the option of redeeming their points in the form of a credit on subsequent bills, or an offline credit fulfillment process. In the scenario where the customer is not presented with a bill, but just a receipt, the response to the customer may simply notify the customer that rewards have been added to their loyalty account.

Further elaboration as to the operation of the native mobile loyalty application 108 is given below.

Processing of Redeem( ) Request

In step 916, upon receiving a Redeem( ) request for the transaction, the loyalty server application 118 will perform validation on the Redeem( ) request data. In the first embodiment, the validation may include:

1. Verify that the total value of the redemption options selected for payment by balance redemption is less than the user's current balance. If not, then respond to the Redeem request with a response value indicating that the redemption failed (REDEEM_FAILED).

2. Verify that the item requested for redemption is allowed to be paid for via redemption credit according to the Reward Redemption Eligibility Check logic.

If the Redeem( ) request passes the validation steps, then in the first embodiment the following actions (the Redemption Transaction) will be performed transactionally (all or nothing):

1. Write the redeemed items to a new customer reward redemption transaction record in loyalty server database 122.

2. Subtract the total redeemed value from the customer's Customer Reward Balance in the customer's customer record of loyalty server database 122.

3. Make a web services call to UpdateTxnInfo1( ) or UpdateTxnInfo2( ) at the POS system server 124 service interface with a request body:

```
<request>
  <add-item>
    <item type=“credit”>
      <name>Mobile Loyalty Credit</name>
      <value>-$50.45</value>
    </item>
  </add-item>
</request>
```

4. Wait for a success response from the POS system server 124 to the UpdateTxnInfo1( ) web services call.

Once the redemption transaction completes successfully, in the first embodiment the loyalty server application 118 responds to the Redeem( ) request from the native mobile loyalty application 108 with the following response:

<response>
<result>OK</result>
</response>

Based on this response the native mobile loyalty application 108 will display a message telling the user the redemption succeeded.

Completion of Payment Transaction

In step 918, a new bill reflecting the application or redemptions of rewards selected by the customer my be printed and presented to the customer. In step 920, following the redemption transaction, the customer provides payment to the merchant for the remaining balance of the bill, if an unpaid balance remains after applying the customer reward credit. The merchant performs the payment transaction at POS Terminal 128, and POS system 138 completes the payment transaction for the remaining balance according to a standard payment transaction process. In step 920, a final receipt is printed. In step 924, upon successful completion of the payment transaction, POS Terminal 128 notifies POS system server 124 of the successful payment closing the transaction. POS system gateway 126 now makes a web services call to the TransactionClosed( ) method at loyalty server application 118:

TransactionClosed(POS_SYSTEM ID, POS_TERMINAL_ID, POS_TRANSACTION_ID, POS_TERMINAL_TIME)

In step 926, loyalty server application 118, having received the TransactionClosed( ) request, performs the following actions:

1. Determine the reward credit earned by multiplying the portion of the charged value paid for through a method other than reward credit (PAID_AMOUNT) by a configured reward earning rate (REWARD_EARNING_RATE). For example, given a paid amount (PAID AMOUNT) of $20 and a REWARD EARNING RATE of 10%, the customer reward credit earned for the transaction is $2.

2. Write the reward credit earned as new customer reward earnings transaction record in loyalty server database 122.

3. Add the total earned reward credit value to the customer's Customer Reward Balance in the customer's customer record of loyalty server database 122.

In step 928, the transaction has completed.

Alternatively, as described in receipt flow variant 2, the complete transaction information, including the value of the transaction (i.e., the total or subtotal), may be encoded in the loyalty code 104 printed on the receipt 103. In this implementation, the loyalty server 118 does not contact the POS system 138 to retrieve the value of the transaction. The transaction data is then used directly by the loyalty server 117 to update the customer rewards account information. Also, in this implementation, the POS loyalty application 125 integrated with the POS system 138 is a simplified version as compared to the version that is integrated in the bill flow variant 1. This is because in this implementation the POS loyalty application 125 prints loyalty codes, and typically need not communicate with the loyalty server 117.

Alternatively, the customer may not be prompted to chose or approve the redemption of points against the value of the bill, reward coupons with the merchant, or other special promotions. Rather, these may be automatically redeemed during the Reward Redemption Eligibility Check based on predetermined rules set by the merchant, the customer, or the loyalty program.

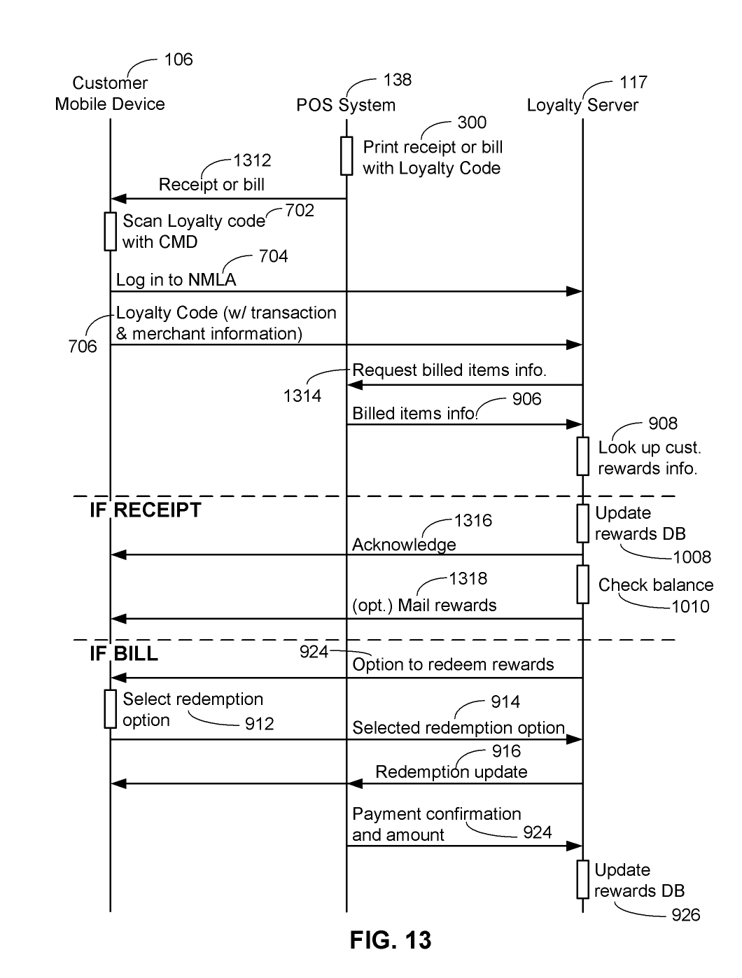

SEQUENCE OF THE FIRST EMBODIMENT-FIG. 13

FIG. 13 illustrates an example sequence of events in the first embodiment under the bill or receipt variants. The diagram includes the customer mobile device 106, the merchant POS system 138, and the loyalty server 117. After an item or service has been delivered by the merchant to the customer, at 300 (corresponding to the first operational phase 300 of FIG. 3) the POS system 138 generates a bill or receipt 103 including a loyalty code 104. Next, at step 1312, the bill or receipt 103 is given to the customer to be scanned by the customer mobile device 106.

Continuing with FIG. 13, at 702 (corresponding to the step of FIG. 7) the customer scans the loyalty code 104 with the customer mobile device 106. Using the customer mobile device 106, the customer then inputs their account login credentials into, or establishes a new account with, the loyalty server 117, at 704. Then, at 706, the loyalty code 104, including the transaction and merchant information is transmitted to the loyalty server 117. Next, at 1314, the loyalty server 117 transmits to the POS system 138 a request for detailed billed items information. The POS system 138, at 906 (corresponding to the step of FIG. 9), then responds with the detailed billed items information. At 908, the loyalty server 117 looks up the customer information in the loyalty server database 122.

If a receipt was given to the customer, the sequence continues at 1008 (corresponding to the step of FIG. 10), at which point the customer's reward balance is updated in the loyalty server database 122. Next, at 1316, the loyalty server 117 sends an acknowledgment to the customer mobile device 106. Then, at 1010, if the customer's rewards balance exceeds a predetermined threshold, an offline reward is optionally mailed to the customer mobile device 106, at 1318.

If a bill is given to the customer, the sequence continues at 910 where the customer, using the customer mobile device 106, is given the option to redeem rewards against the bill. At 912, the customer selects, or declines to select, a reward on the native mobile loyalty application 108. Next, at 914, the customer's selection is transmitted back to the loyalty server 117. The loyalty server 117, at 916, communicates the reward redemption, and the remaining bill balance, to the merchant's POS system 138 and the customer mobile device 106. The customer then pays the merchant for the remainder of the bill, and at 924, the payment confirmation and amount is transmitted to the loyalty server 117. Finally, the loyalty server 117, at 926, updates the loyalty server database 122 with the additional customer reward information based on the amount of the customer's 1302 payment to the POS system 138.

Alternatively, the POS system 138 may generate a new bill following step 916, and the bill may be given to the customer. In another alternative, following final payment, a receipt may be generated by the POS_system 138 and given to the customer.

FIRST ALTERNATIVE EMBODIMENT-MOBILE RETAIL LOYALTY NETWORK WITH GENERIC QR CODE READER SUPPORT 200

FIG. 2 shows a block diagram of a first alternative embodiment of a Mobile Retail Loyalty Network with Generic QR Code Reader Support 200. The Mobile Retail Loyalty Network with Generic QR Code Reader Support 200 includes a receipt 103, a customer mobile device 105, a wireless network 112, a wireless network gateway 114, a WAN (wide area network) Network 116, a POS (Point-of-Sale) system gateway 126, a POS system 138, a loyalty system gateway 120, a web server 130, and a loyalty server 117. The receipt 103 includes a loyalty code data container 102, and the loyalty code data container 102 includes a loyalty code 104. The customer mobile device 105 includes a mobile web browser 136, a generic QR code reader 134, and a camera 110. The POS system 138 includes a POS system server 124 and POS terminals 128. The POS System Server includes a POS Loyalty Application 125. The web server 130 includes a web mobile loyalty application 132. The loyalty server 117 includes a loyalty server application 118 and a loyalty server database 122. The web server 130 may be implemented on the same physical server or servers as the loyalty server 117, or on one or more separate physical servers.

In Mobile Retail Loyalty Network with Generic QR Code Reader Support 200, communications between the devices occurs similarly to communication in FIG. 1, with some additions. The web server 130 and loyalty server 117 are operated by a Loyalty Program Service Provider, and the web server 130 communicates with the loyalty system gateway 120. Also, the loyalty server 117 communicates with the web server 130.

The loyalty code 104, is printed on a receipt 103 that is scanned or photographed by camera 110. The loyalty code 104 data is then extracted from the image and communicated to the mobile web browser 136 by the generic QR code reader 134. The loyalty code 104 data is then communicated over the WAN network 116 to the web mobile loyalty application 132. The Loyalty Program Service Provider, who usually operates the web server 130 and the loyalty server 117, typically manages customer loyalty programs for many different merchants on the loyalty server 117.

Alternatively, the features of FIGS. 1 and 2 may be combined within a single system, such that the customer may either use the mobile web browser 136, or the native mobile loyalty application 108 to access the loyalty program and the loyalty server 117.

Similar to the first embodiment, in general, information related to the customer's transaction with the merchant is encoded by the POS system 138 in the loyalty code 104, and subsequently printed on the receipt 103 in the form of the loyalty code data container 102. When the loyalty code data container 102 is scanned or photographed by the customer using the customer mobile device 105, the loyalty code 104 is then extracted by the generic QR code reader 134. The loyalty code 104 at this stage is typically in the form of a web address (URI), and is passed to the mobile web browser 136. The mobile web browser 136 then executed the URI and may then communicate with the web server 130 and the web mobile loyalty application 132, and the POS_system 138 to allow the customer to log in to their account, or create a new account, with the Loyalty Program Service Provider. The customer's account information, including loyalty network points, may also be retrieved from the loyalty server 117. Redemption of loyalty network points may be made by the customer through communication with the POS system 138, and automated communications between the web server 130, the loyalty server 117, and the POS system 138. Loyalty network points may also be added to the customer's account on the loyalty server 117.

Existing merchants may join the Mobile Retail Loyalty Network with Generic QR Code Reader Support 200 in a manner similar to that described in the first embodiment.

Customer Mobile Device

The customer mobile device 105 has generic QR code reader 134 installed and Mobile Web Browser 136 installed. customer mobile device 105 also includes camera 110 that may be controlled by software installed on the customer mobile device 105. Generic QR code reader 134 has the capability to control camera 110 such that images or video may be captured with camera 110 and provided in digital form to generic QR code reader 134.

Loyalty Server Application Connectivity

The web server 130 is configured to provide a web application hosting environment to the web mobile loyalty application 132. Web mobile loyalty application 132 provides dynamic web site functionality accessible from mobile web browser 136. Web mobile loyalty application 132 is connected to loyalty system gateway 120. Loyalty system gateway 120 is connected to WAN network 116. Hence web mobile loyalty application 132 has data communications access to WAN network 116 and to network devices with data communications access to WAN network 116. Also, web mobile loyalty application 132 is connected to loyalty server application 118.

Also, web mobile loyalty application 132 is connected to loyalty server database 122 that stores customer records, customer reward redemption transaction records, customer reward earnings transaction records, POS System Server registration records, and Web Application session records. In the first alternative embodiment, these record types include the following information. Customer records include customer username (USERNAME), password (SHA1_PASSWORD), and customer reward balance information. Reward redemption transaction records include customer id, POS system id (POS_SYSTEM_ID), transaction time (POS_TERMINAL₁₃ TIME), unique transaction id (POS_TRANSACTION_ID), redeemed item (ITEM_LIST), and redeemed value information. Reward earnings transaction records include customer id, POS system id (POS_SYSTEM_ID), transaction time (POS_TERMINAL₁₃ TIME), unique transaction id (POS_TRANSACTION_ID), paid value, and earned value information. Web application session records include session id, and a key-value pairs storage field.

Turning now to again to FIG. 3, FIG. 3 shows a flow diagram illustrating the operational phases of the Mobile Retail Loyalty Network with Generic QR Code Reader Support 200 (of FIG. 2). There are three operational phases: in phase 300, the loyalty code data container 102 (of FIG. 2) is generated and presented to the customer either on a bill or receipt, or affixed to a POS system or terminal; in phase 302, the loyalty code 104 (of FIG. 2) data is captured by the customer utilizing the customer mobile device 105, or some other capable device; in phase 304, communications take place between the customer mobile device 105, POS system 138, web server 130, and loyalty server 117 (all of FIG. 2) to redeem points, credit points toward the transaction, and add points to the customer's account, among other communications.

FIRST OPERATIONAL PHASE 300 OF THE FIRST ALTERNATIVE EMBODIMENT-PRESENTATION OF LOYALTY CODE DATA CONTAINER

The First Operational Phase 300 proceeds as in the first embodiment.

SECOND OPERATIONAL PHASE 302 OF THE FIRST ALTERNATIVE EMBODIMENT-ACQUIRE LOYALTY CODE DATA CONTAINER 102 AND TRANSMIT

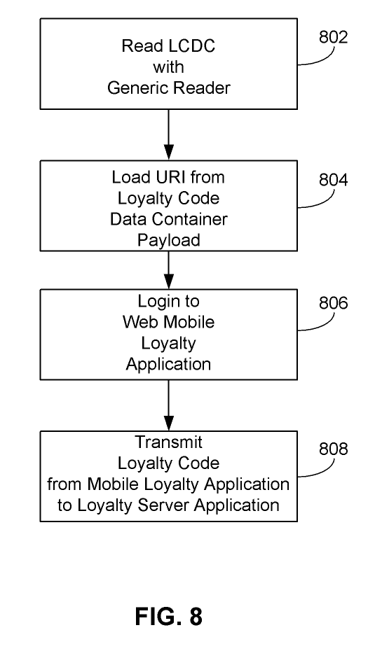

FIG. 8 shows a flow diagram of the second operational phase 302, when the loyalty code 104 is acquired and transmitted using the generic QR code reader 134 and mobile web browser 136. The second operational phase 302, in the first alternative embodiment, includes the customer using generic QR code reader 134 to scan and read loyalty code data container 102 (a QR Code in this embodiment) (in step 802); decoding loyalty code data container 102 to extract loyalty code 104 in the form of a URI that is then passed to the mobile web browser (in step 804); logging into the web mobile loyalty application 132 (in step 806); and transmitting the loyalty code 104 from the web mobile loyalty application 132 to the loyalty server application 118 (in step 808). This flow will be further elaborated next.

Generic QR Code Reader Application

Many mobile phones with cameras (referred to onwards as cameraphones) and other mobile devices equipped with cameras (such as smartphones, laptops, and tablets) are sold with generic QR code reader software pre-installed or available for download. Many mobile phones and many other mobile devices are sold with web browsers pre-installed or available for download.

In step 802 of FIG. 8, generic QR code reader 134 reads QR Code (loyalty code data container 102) through camera 110, decodes QR code (loyalty code data container 102), recognizes the encoded loyalty code 104 as a URI, and, in step 804, performs the generic QR code reader's 134 default action for QR codes including URIs. This default action for generic QR code readers is common to either load the URI in mobile web browser 136, or to prompt the user for confirmation to proceed with loading the URI in mobile web browser 136.

Loyalty Code Landing URL Processing

In step 806 of FIG. 8, when the URI is loaded in mobile web browser 136, the web server 130 serving the example-loyalty-domain.com domain will receive an HTTP request for the URI “https://example-loyalty-domain.com/landing/city-coffee-shop%2C0124%2C0010230% 2C2010-04-02T09%3A57Z”. The web server 130 is configured to handle this request by passing it to web mobile loyalty application 132. Web mobile loyalty application 132 processes the request as follows:

1. Log the request including the Request URI, the source IP address of the request, and the time of the request

2. Decode loyalty code 104 according to the following steps:

2a. De-URL Encode the payload string, resulting in: https://example-loyalty-domain.com/landing/city-coffee-shop,0124,0010230,2010-04-02T09:57Z

2b. Strip the leading characters up to the last “I” character, resulting in: city-coffee-shop,0124,0010230,2010-04-02T09:57Z

2c. Split the string on the “,” character, resulting in the recovery of the original data components embedded in loyalty code 104: LOYALTY_SYSTEM_DOMAIN=example-loyalty-domain.com POS_SYSTEM_ID=city-coffee-shop POS_TERMINAL _ID=0124 POS_TRANSACTION ID=0010230 POS_TERMINAL₁₃ TIME=2010-04-02T09:57Z

3. The customer's mobile web browser 136 may have support for cookie capability according to IETF RFC 2965 (Internet Engineering Task Force, Network Working Group, Request for Comments: 2965). If mobile web browser 136 supports cookie capability, web mobile loyalty application 132 may make use of this cookie capability to enable a long-running session based on a prior login authentication, allowing the user to skip re-authentication. If present in the HTTP request, process the “Cookie” header by retrieving the embedded session ID from the “session-id” cookie and retrieving the web application session record from loyalty server database 122, resume the user's previously authenticated session, and skip steps 4 and 5 and section “Customers Not Resuming a Previously Authenticated Session” below, and proceed directly to section “Post Authentication Processing”. This enables a customer that has previously used the customer mobile device 105 to complete login authentication to web mobile loyalty application 132 without re-entering their login credentials.

4. If a “Cookie” header is not present, create a new session, storing the data components decoded from loyalty code 104. Store this new session as a web application session record in loyalty server database 122, and set the “Set-Cookie2” header with a cookie named “session-id” embedding the session ID for inclusion in the HTTP response.

5. Respond with a QR Code Landing Page including the following components:

5a. A call to action stating “To collect your loyalty rewards for this bill, please download the Native Mobile Loyalty application for your mobile device or Sign Up for mobile web access. If you already have a mobile web login, login now.”

5b. A link with the text “Download Native Mobile Loyalty”

5c. A link with the text “Sign Up for mobile web access to Mobile Loyalty”

5d. A username text field

5e. A password text field

5f. A button with the text “Login”

Customers Not Resuming a Previously Authenticated Session

At this point a customer that has not previously used the system may download native mobile loyalty application 108 or register to use the system via mobile web browser 136.

Clicking the download link will use well-established techniques of mobile device type detection based on the User-Agent string in the HTTP request header to determine the most appropriate version of the native mobile loyalty application 108 to provide to the customer based on mobile device manufacturer and model, and optionally other parameters such as country and language and locale code provided in the standard HTTP request headers. Following the download process the customer may choose to load the native mobile loyalty application 108 and proceed as described in the first embodiment.

In the first alternative embodiment, clicking the Sign Up link will present the user with a sign up form that includes, for example:

1. An email address text field

2. A password text field

3. A password confirmation text field

4. A button with the text “complete signup”

In step 808 of FIG. 8, upon completion of the fields and clicking the “complete signup” button, web mobile loyalty application 132 will make a web services call to CreateCustomer( ) at loyalty server application 118: CreateCustomer(username, sha1_password).

Loyalty server application 118 will then create a new customer record in loyalty server database 122 with the provided username, SHA1 hash of the customer's password, and a customer reward balance of 0.

Post-Authentication Processing

Web mobile loyalty application 132 now initiates a web services call to the Acquire( ) web service method of loyalty server application 118: Acquire(USER, POS_SYSTEM_ID, POS_TERMINAL_ID, POS_TRANSACTION_ID, POS_TERMINAL₁₃ TIME)

The authentication credentials for this web services call are provided via standard HTTP Authentication using the Digest Access Authentication Scheme as described in RFC 2617. The authentication credentials identify web mobile loyalty application 132 to loyalty server application 118.

THIRD OPERATIONAL PHASE 304 OF THE FIRST ALTERNATIVE EMBODIMENT-REDEEM AND CREDIT

FIG. 9 shows a flow diagram of the third operational phase 304, when the merchant has selected bill and receipt flow (in other words, the POS system 138 supports providing the customer with either a bill or a receipt). In step 904, if the merchant supports bill and receipt flow, the flow continues to step 906. In step 906, upon receiving an Acquire( ) service request from the web mobile loyalty application 132, loyalty server application 118 looks up the provided POS_SYSTEM_ID in the POS_Systems Database and retrieves the hostname or IP address of the corresponding POS system server 124. Loyalty server application 118 then sends a web services request to POS system server 124:

GetTxnInfo1(POS_TERMINAL_ID, POS_TRANSACTION_ID)

Since the Mobile Retail Loyalty Network with Generic QR Code Reader Support 200 supports simultaneous connection and transaction processing with many POS Systems at once, provided by different POS System vendors, the following description of POS system server 124 processing of GetTxnInfo1( ) is an example.

POS System Server 124 Processing of GetTxnInfo1( )

This processing phase proceeds as in the first embodiment. Reward Redemption Eligibility Check

In step 908, loyalty server application 118 then performs a Reward Redemption Eligibility Check. The Reward Redemption Eligibility Check determines a set of redemption options to be provided to the customer. The Reward Redemption Eligibility Check may be driven by static rules or configurable rules provided by the merchant In the first alternative embodiment the Reward Redemption Eligibility Check performs the following processing:

If CUST_REWARD_BALANCE >BILL_TOTAL (in other word, if the customer's reward balance is greater than the total value of the bill), then respond to the Acquire( ) request with the following response body:

```
  <response>
    <redemption-option>
      <prompt>Would you like to redeem $50.45 of your reward
balance and get this meal for free?</prompt>
      <item>Total</item>
    </redemption-option>
  </response>
```

Alternatively, the Reward Redemption Eligibility Check may check whether the customer's reward balance is greater than a portion of the bill, or greater than the value of particular items on the bill. In this case, the loyalty server application 118 would respond to the Acquire( ) request with a prompt to the customer, asking them if they would like to redeem a portion or all of the reward balance against the total value of the bill, or redeem a portion or all of the reward balance against the value of a particular item from the bill. As another alternative, the Reward Redemption Eligibility Check may prompt the customer to redeem rewards that give the customer a percent discount on the bill, or free items. The rewards available to the customer may include coupons for discounts on the bill, or other merchant determined rewards. Alternatively, the redemption of points against the value of the bill, reward coupons with the merchant, or other special promotions may be automatically redeemed during the Reward Redemption Eligibility Check based on predetermined rules set by the merchant, the customer, or the loyalty program.

In step 910, the response to the Acquire( ) request, including the customer prompt, is actually transmitted to web mobile loyalty application 132. The loyalty server application 118 will then wait for a Redeem( ) request from the web mobile loyalty application 132.

Redemption Option Selection

In step 912, the web mobile loyalty application 132, having received the Acquire( ) response including one or more redemption-option elements, returns an web page providing a visual prompt to the customer including the prompt text, with a “Redeem” button response option and a “No Thanks” button response option.

If the customer selects the “No Thanks” option, the redemption portion of the Third Operational Phase 304 is complete. If the customer selects the “Redeem” option, then web mobile loyalty application 132 makes a Redeem( ) web services call to loyalty server application 118.

Step 912, is optional, and the customer may choose not to redeem rewards. Alternatively, the merchant may give the customer the option of redeeming their points in the form of a credit on subsequent bills, or an offline credit fulfillment process. In the scenario where the customer is not presented with a bill, but just a receipt, the response to the customer may simply notify the customer that rewards have been added to their loyalty account.

Processing of Redeem( ) Request

In step 916, upon receiving a Redeem( ) request for the transaction, the loyalty server application 118 will perform validation on the Redeem( ) request data. In the first alternative embodiment, the validation may include:

1. Verify that the total value of all the redemption options selected for payment by balance redemption is less than the user's current balance. If not, then respond to the Redeem request with a response value indicating that the redemption failed (REDEEM_FAILED).

2. Verify that the item requested for redemption is allowed to be paid for via redemption credit according to the Reward Redemption Eligibility Check logic.

If the Redeem( ) request passes all validation steps, then in the first alternative embodiment the following actions (the Redemption Transaction) will be performed transactionally (all or nothing):

1. Write the redeemed items to a new customer reward redemption transaction record in loyalty server database 122.

2. Subtract the total redeemed value from the customer's Customer Reward Balance in the customer's customer record of loyalty server database 122.

3. Make a web services call to UpdateTxnInfo1( ) or UpdateTxnInfo2( ) at the POS system server 124 service interface with a request body:

```
<request>
  <add-item>
    <item type=“credit”>
      <name>Mobile Loyalty Credit</name>
      <value>-$50.45</value>
    </item>
  </add-item>
</request>
```

4. Wait for a success response from the POS system server 124 to the UpdateTxnInfo1( ) web services call.

Once the redemption transaction completes successfully, in the first alternative embodiment the loyalty server application 118 responds to the Redeem( ) request from web mobile loyalty application 132 with the following response:

<response>
<result>OK</result>
</response>

Based on this response the web mobile loyalty application 132 will display a message telling the user the redemption succeeded.

Completion of Payment Transaction

This sequence, encompassing steps 918-928, proceeds as in the first embodiment.

SECOND ALTERNATIVE EMBODIMENT

This alternative embodiment describes an alternative method for customer reward credit balance redemption via the offline delivery of a payment instrument that in the first-described embodiment is a retail store value card co-branded between the merchant and the mobile loyalty network, but may instead be another form of payment instrument such as a merchant-branded retail stored value card, a pre-paid card enabled on a credit card processing network such as Visa, a pre-paid debit card enabled on an interbank network such as Cirrus, PLUS, or Interac, or a paper voucher or gift certificate with a unique id. Alternatively, the features of FIGS. 1 and 2, including the descriptions of the first embodiment and the first alternative embodiment, may be combined within a single system, and either or both may including the features of this second alternative embodiment, as is described.

FIRST AND SECOND OPERATIONAL PHASES 300 AND 302 OF FIG. 3 OF THE SECOND ALTERNATIVE EMBODIMENT

These phases may proceed as in either the first embodiment or the first alternative embodiment.

THIRD OPERATIONAL PHASE 304 OF FIG. 3 OF THE SECOND ALTERNATIVE EMBODIMENT-REDEEM AND CREDIT

This phase proceeds as in either the first embodiment or the first alternative embodiment, with the following modifications: In reference to FIG. 9, the Reward Redemption Eligibility Check procedure (steps 904-908) is omitted, the Redemption Option Selection procedure (steps 910-914) is omitted, the Processing of Redeem( ) Request procedure (steps 916-918) is omitted, and the Completion of Payment Transaction procedure (steps 920-928) is modified as described below.

FIG. 10 shows a flow diagram of this modified third operational phase 304, when the merchant has selected only receipt flow (in other words, the POS system 138 supports providing the customer with a receipt, or the merchant has selected to provide the customer with a receipt and not a bill).

Completion of Payment Transaction

Turning now to FIG. 10, in step 1002 the customer provides payment to the merchant for the value of the bill. The merchant performs the payment transaction at POS Terminal 128, and POS system 138 completes the payment transaction for the remaining balance according to a standard payment transaction process. Upon successful completion of the payment transaction, POS Terminal 128 notifies POS system server 124 of the successful payment closing the transaction. POS system gateway 126 now makes a web services call to the TransactionClosed( ) method at loyalty server application 118:

TransactionClosed(POS_SYSTEM ID, POS_TERMINAL_ID, POS_TRANSACTION_ID, POS_TERMINAL₁₃ TIME)

loyalty server application 118, having received the TransactionClosed( ) request, performs the following actions:

1. In step 1006, determine the reward credit earned by multiplying the portion of the charged value paid for (PAID_AMOUNT) by a configured REWARD_EARNING_RATE. For example, given a PAID_AMOUNT of $20 and a REWARD_EARNING_RATE of 10%, the customer reward credit earned for the transaction is $2.

2. In step 1008, write the reward credit earned as new customer reward earnings transaction record in loyalty server database 122.

3. Add the total earned reward credit value to the customer's Customer Reward Balance in the customer's customer record of loyalty server database 122.

4. In step 1010, check whether Customer Reward Balance is greater than a configured offline redemption trigger balance (OFFLINE_REDEMPTION_TRIGGER_BALANCE). If so, then trigger a business process for payment instrument fulfillment by postal mail. Such an offline credit fulfillment process may include a mailed redeemable merchant-branded (or unbranded) gift card, which may optionally be rechargeable upon additional future credit fulfillments.

In step 1012, the transaction is concluded.

Alternatively, the customer may request or initiate, through the web mobile loyalty application 132 or the native mobile loyalty application 108, the offline credit fulfillment process.

FUNCTIONALITY OF THE NATIVE MOBILE LOYALTY APPLICATION 108 AND THE WEB MOBILE LOYALTY APPLICATION 132

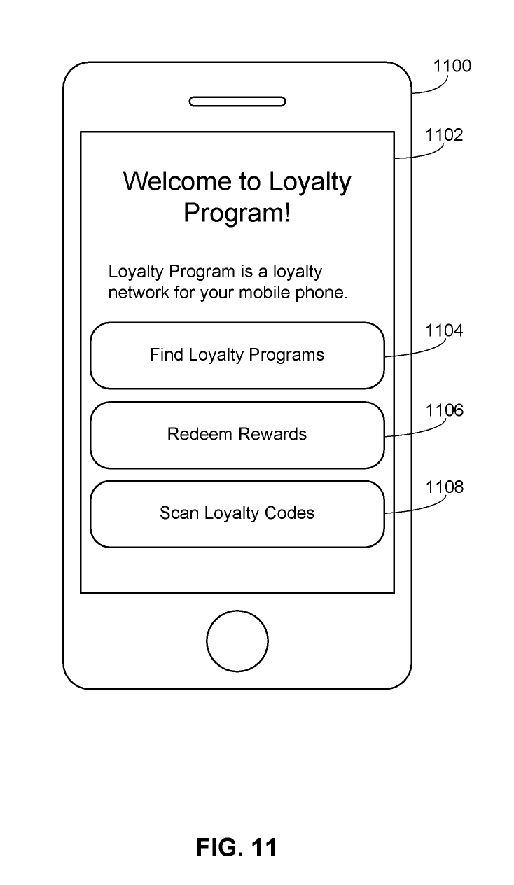

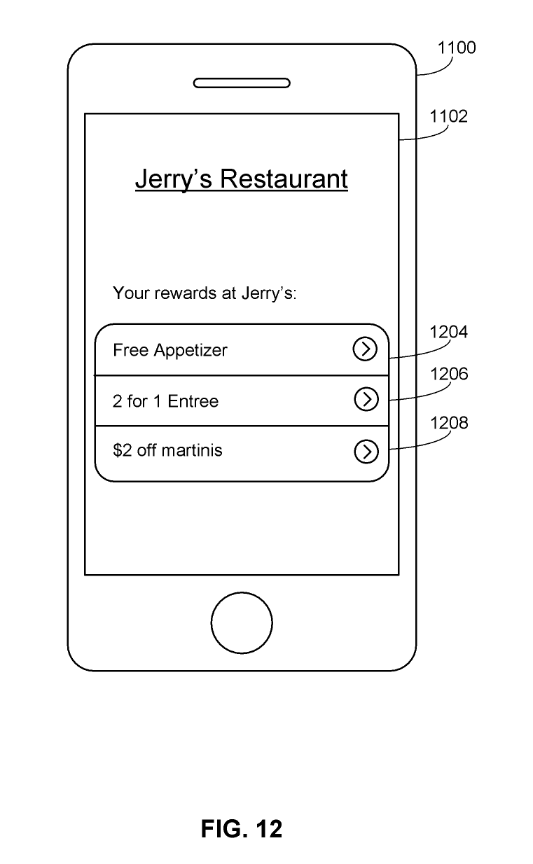

FIGS. 11 and 12 illustrate screen displays that are representative of the native mobile loyalty application 108 of FIG. 1 or the web mobile loyalty application 132 of FIG. 2. FIG. 11 includes a smartphone 1100, a display 1102, and buttons 1104, 1106, and 1108 within the loyalty application. FIG. 12 includes a smartphone 1100, a display 1102, and buttons 1204, 1206, and 2008 within the loyalty application.

In the first embodiment, the native mobile loyalty application 108 is part of the smartphone 1100 (corresponding to the customer mobile device 106 of FIG. 1), and may communicate with the camera 110 and the wireless network 112. In the first alternative embodiment the web mobile loyalty application 132 is part of the web server 130 (of FIG. 1), and may be viewed and accessed on the smartphone 1100 through the mobile web browser 136, which may communicate with the generic QR code reader 134, camera 110, and wireless network 112.

In operation, the customer with the smartphone 1100 joins the customer loyalty network by first scanning the loyalty code 104 found on a receipt or bill, or by directly inputting into their mobile web browser 136, the URI associated with the loyalty code 104 found on the receipt or bill. By scanning the loyalty code 104, or inputting the URI into the mobile web browser 136, the customer will be brought to the web mobile loyalty application 132. The web mobile loyalty application 132 will then give the customer the option of downloading the native mobile loyalty application 108 and subsequently signing up for the loyalty network and the loyalty program of the merchant whose receipt or bill was scanned, or signing up directly through the web mobile loyalty application 132 (as described above under the heading Loyalty Code Landing URL Processing). The web mobile loyalty application 132 may be branded with the logo of the merchant from which the loyalty code 104 originated, or with the logo of the Loyalty Program Service Provider. The customer may join the Loyalty Program Service Provider's loyalty program, or alternatively they may join the merchant-specific loyalty program. Alternatively, after signing up for the loyalty network, the customer may join the Loyalty Program Service Provider's coalition loyalty program.

If the customer is already a member of the loyalty network, they may, instead of signing up, input the username and password for their loyalty network account. As described above under the heading Loyalty Code Landing URL Processing, if the customer's mobile web browser 136 supports “cookies,” and they have previously logged into the loyalty network, they may be authenticated and logged in automatically. Alternatively, if the customer is using a smartphone with the native mobile loyalty application 108, they may log in or be logged in automatically to that application. If the customer is using the web mobile loyalty application 132 and their smartphone supports native applications, they may alternatively choose to download the native mobile loyalty application 108 and proceed with the rewards signup or login to the loyalty network.

If the customer has installed the native mobile loyalty application 108, they may, as shown in FIG. 11, choose to find merchant-specific loyalty programs, redeem their accumulated rewards, or scan a loyalty code. If the customer chooses to find loyalty programs, they may be presented with a list of participating loyalty program merchants, or with a map that displays the locations of merchant who participate in loyalty programs. The list and map may be configured to display the merchants that are nearest to the location of the customer who is searching. The customer also has the option of searching for merchants by category of merchant (for example: food, grocery, clothing retailer, etc.), and sub-category (for example: fast-food, burgers, Italian, etc.). Upon choosing a specific retailer, the customer may be presented with the locations of the merchant, directions to get to the merchant, the option to join the merchant's loyalty program, and reviews of the merchant.

If the customer chooses to redeem rewards, they are presented with a list of current merchants with whom the customer has loyalty program memberships. The customer then is given the option of redeeming rewards either on specific transactions, or for an offline mail delivery of a rewards card (such as a refillable merchant-branded gift card).

If the customer chooses to scan a loyalty code (either one that was produced on a receipt or bill, or affixed to a POS_terminal, by a merchant operating a POS_system), the camera of the customer's smartphone 1100 is activated and they may then take a picture of a loyalty code. The loyalty code is then decoded either by the generic QR code reader 134, or the native mobile loyalty application 108, and the associated transaction information is transmitted either to the loyalty server application 118, or the web server 130. The loyalty server application 118 then returns information to the customer about the availability of rewards for the associated merchant and transaction. Depending on the type of transaction, POS system, and the merchant's preference, the customer will then be given the option to redeem their rewards offline, or immediately apply them to the present transaction. As shown in FIG. 12, the customer may be given the option of redeeming their rewards immediately, for example, to get a 2 for 1 entree, or a free appetizer, or $2 off a meal. The customer may then press the button on the smartphone to instantly redeem their rewards. Subsequently, the value of the redemption is deducted from the customer's bill (through communication between the smartphone, the loyalty server 117, and the POS system 138, as described previously), and the customer may then proceed to pay the remainder of the bill.

In transactions where the merchant requires fast completion (such as in fast-food establishments), the customer may not have the option of immediately redeeming rewards before paying their bill. In this scenario, the customer scans the loyalty code printed on the receipt after completing the transaction, at which point rewards are redeemed, and the customer's loyalty membership account with the merchant is adjusted based on the new purchase from the merchant The customer may then choose to redeem additional rewards in a future transaction, or in the form of an offline mail delivery of the rewards.

Alternatively, the customer may use the native mobile loyalty application 108 or the web mobile loyalty application 132 to pay the full value of their bill or transaction. In this embodiment, the Loyalty Program Service Provider, operating the loyalty server 117, stores the customer's payment information, such as a credit card, along with the customer's account information, in the loyalty server database 122. The customer, upon scanning a loyalty code, then chooses to redeem rewards and pay the remainder of the bill immediately through the native mobile loyalty application 108 or the web mobile loyalty application 132.

Alternatively, the POS system 138 may not produce a receipt of bill, but may display the loyalty code 104 on a video display. Alternatively, the POS system 138 may communicate the transaction information to the customer mobile device 106 or 105 through a wireless communications protocol, such as Near Field Communications (NFC), IEEE 802.11 technical standards (“WiFi”), IEEE 802.16 standards (“WiMax”), or other wireless communications protocol.

The customer may alternatively earn cash, rewards points, merchant-specific rewards points, or specific redeemable rewards (such as coupons and free items) as part of the rewards programs.

The native mobile loyalty application 108 and the web mobile loyalty application 132 may alternatively be branded under the name of the Loyalty Program Service Provider, the merchant, or both. Alternatively, merchants may have their own rewards brand, with a branded native mobile loyalty application 108 or the web mobile loyalty application 132, and unique customer login.

The smartphone 1100 may alternatively be a cell-phone, a tablet computer, a laptop computer, or some other computerized device.

The native mobile loyalty application 108 or the web mobile loyalty application 132 may alternatively be integrated with a merchant's ecommerce website. In this embodiment the customer may see the value of their rewards account, and available redemption options, as they shop in the merchant's web storefront. The customer may then immediately choose to redeem rewards from their associated rewards account while still on the merchant's website.

The native mobile loyalty application 108 or the web mobile loyalty application 132 may alternatively be voice controlled.

In another alternative, the POS loyalty application 125 is configured to be installed on the POS terminal 128, or both on the POS terminal 128 and the POS server 125.

In yet another alternative, the Mobile Retail Loyalty Network (100 and 200) may include a separate hardware device attached to the POS system 138 that intercepts, decodes, and augments the print data stream (the stream of data that is transmitted to the POS system's printing device or customer-facing display) of the POS system 138. In this alternative, the print data stream of the POS system 138 is decoded by the separate hardware device to obtain transaction information (such as the transaction ID, the POS system and terminal ID, the timestamp, and the transaction subtotal). The separate hardware device is enabled to then augment the print data stream to cause the code image (such as a QR code) to be printed on the receipt or bill (and/or displayed on a customer-facing display). The use of such a hardware device may be desirable for merchants that do not wish to add software to their POS systems for generating the code images.

Accordingly, several advantages may be realized:

1. A simpler discovery process: By printing QR codes on bills or receipts, along with a call-to-action to engage users and customers in a loyalty network and associated loyalty programs of participating merchants, the process of discovering the loyalty program is constant without being irritating. In an age where consumers are bombarded with advertising that they consciously filter out, a sales receipt is something they actually hold in their hands and, in many cases read. It is a natural place to discover the mobile phone-based loyalty program for a participating retailer or merchant.

2. An easier to deploy process for tracking earned rewards: The participating customer simply scans a loyalty code (such as a QR code) for an eligible purchase and does not rely on the retailer or merchant to have a compatible scanning or identifying device. Additionally, merchants with pre-existing POS systems may easily implement a loyalty program by simply installing a loyalty application. Subsequently, the merchant may participate in the loyalty network or a standalone loyalty program with no additional configuration or difficulty.

3. A more convenient way to collect rewards: Value may be created by enabling merchant retail customers to collect loyalty points via a device that most consumers have on their person most of the time: a mobile phone or smartphone, especially if the loyalty program is part of a loyalty network with a single login for all associated loyalty programs. Inconveniences associated with remembering to carry around multiple rewards cards and identifiers for multiple rewards or loyalty programs in which consumers are enrolled are reduced.

The described system is also a more effective method of creating continued awareness and participation: By causing retailers and merchants to print loyalty codes on their receipts, consumers may be reminded of the program on a regular basis, which may make them more likely to participate and earn rewards.

4. New customer loyalty program participation may be increased: Many customers who are not inclined to carry or use loyalty cards may participate in a loyalty program if it could be managed via their mobile phone or smartphone. Where large purchases are involved, many loyalty program participants may make a point of guiding purchases to a particular retailer where the participant may be able to collect points (for example, restaurant reservations for a large group, large business expenditures for which an employee would be reimbursed by their employer for the actual purchase value of the transaction, etc.)

CHECK-IN AND PAYMENT APPLICATIONS

The various methods described herein for encoding transaction information in code images provided on transaction records (bills or receipts) or POS displays, and for conveying such information to a server application, can also be used for applications that do not involve customer loyalty programs. For example, the disclosed methods can be used to enable users of a social networking type system to “check in” with a particular merchant or merchant location. In such embodiments, the server application may be part of a social networking system, and may use the received transaction and authentication information to register/log the customer's visit in association with the transaction. This would allow the merchant to ensure that only those visits that involve transactions are registered. As another example, the disclosed methods may be used by a payment service to enable a customer to use previously recorded payment information, such as a credit card number, to pay the merchant for the transaction. Further, a given system may implement a combination of these applications (e.g., a loyalty program in combination with social network check-in; a loyalty program in combination with a payment service; or a payment service in combination with social network check-in). Thus, some embodiments of the invention are not limited to customer loyalty programs.

CONCLUSION

The various functions and processes described above may be embodied in, and controlled by, executable code modules stored in non-transitory computer storage. Each of the physical systems described above, including the mobile devices 105, 106, the POS system 138, the loyalty server 117, and the web server 130, typically includes at least one physical processor that executes code modules, a memory, and persistent storage. The loyalty server database 122 may be implemented in computer storage as a relational database, a flat file system, or any other type of computer data repository.

The various features of the embodiments described above may be combined in various ways to create additional embodiments. All such combinations and embodiments are intended to be supported by this disclosure. As one example, all of the features and associated process flows described above may be implemented in combination within a given system, in which case each merchant may decide which features to enable.

While particular elements, embodiments, and applications have been shown and described, the invention is not limited thereto. Numerous modifications may be made by those skilled in the art without departing from the scope of the invention, which is defined by the claims.

What is claimed is:

1. A system for implementing a loyalty program, the system comprising:
a server system that stores loyalty program account data of customers of a merchant, said server system accessible over a network;
a point-of-sale system that is configured to convey, to a mobile device of a customer, transaction information associated with a transaction between a customer and the merchant; and
a mobile application configured to run on the mobile device of the customer, said mobile application configured to send the conveyed transaction information, and authentication information associated with the customer, via a wireless network to the server system;
wherein the server system is configured to use the information received from the mobile device to, at least, credit a loyalty program account of the customer for said transaction.

2. The system of claim 1, wherein the point-of-sale system is configured to convey the transaction information to the mobile device by generating a code image that is adapted to be optically scanned by the mobile device.

3. The system of claim 1, wherein the point-of-sale system is configured to convey the transaction information to the mobile device by Near Field Communications.

4. The system of claim 1, wherein the point-of-sale system is configured to communicate over the network with the server system regarding the transaction, and to reduce a transaction amount of the transaction to reflect a redemption of loyalty program credits.

5. A method performed by a point of sale system to enable customers to use their mobile devices to participate in a loyalty program, the method comprising:
generating a uniform resource identifier that is associated with a point of sale transaction with a customer, said uniform resource identifier including an address portion that includes a network address associated with a loyalty program system that maintains loyalty program accounts of customers, the uniform resource identifier additionally including transaction data associated with the point of sale transaction;
generating a code image capable of being scanned by a mobile device of the customer, said code image including an encoded representation of the uniform resource identifier; and
printing the code image on a bill or receipt associated with the transaction, to thereby enable the customer to access the loyalty program system by scanning the printed code image with the mobile device.

6. The method of claim 1, wherein the transaction data included in the uniform resource identifier includes a transaction identifier.

7. The method of claim 6, wherein the transaction data included in the uniform resource identifier additionally includes at least one of the following: (1) a point of sale terminal identifier, (2) a point-of-sale system identifier, (3) a timestamp.

8. The method of claim 6, wherein the transaction data included in the uniform resource identifier additionally includes a transaction subtotal.

9. The method of claim 1, wherein the network address comprises a domain name associated with the loyalty program system.

10. The method of claim 1, further comprising, by the point of sale system, receiving, from the loyalty program system, an update message that reflects a redemption of loyalty program credits associated with the customer.

11. The method of claim 10, further comprising, by the point of sale system, reducing a monetary amount associated with said point of sale transaction based on the update message.

12. The method of claim 11, wherein the update message reflects a redemption option selected by the customer via the mobile device.

13. The method of claim 1, further comprising transmitting additional information regarding the transaction from the point of sale system to the loyalty program system in response to a request from the loyalty program system.

14. The method of claim 1, wherein the code image is a QR code image.

15. A point of sale system, comprising:
a point of sale terminal, said point of sale terminal configured to generate, for a customer, a transaction record that includes a code image capable of being scanned by a mobile device of the customer, said code image having encoded therein a uniform resource identifier that includes transaction information associated with a transaction between the customer and a merchant, said uniform resource identifier associated with a server application that is configured to receive and process the transaction information.

16. The point of sale system of claim 15, wherein the point of sale terminal is configured to print the code image on a receipt for said transaction.

17. The point of sale system of claim 15, wherein the point of sale terminal is configured to print the code image on a bill for said transaction.

18. The point of sale system of claim 17, further comprising:
a point of sale system server coupled to said point of sale terminal, wherein the point of sale system server is configured to communicate with the server application in connection with said bill, and to reduce a monetary amount associated with the bill based on information received from the server application.

19. The point of sale system of claim 15, wherein the point of sale terminal is configured to display the code image on a display screen.

20. A system for implementing a loyalty program, comprising:
a database that stores loyalty program account data of users, said database comprising non-transitory computer storage; and
a server application that accesses the database, said server application configured to receive, from a mobile device of a user, transaction data obtained by the mobile device by scanning an encoded portion of a transaction record, said transaction record generated by a point of sale system of a merchant in connection with a transaction between the user and merchant, said server application additionally configured to communicate over a network with the point of sale system to, at least, provide loyalty program credit to the user for the transaction.

21. The system of claim 20, wherein the transaction record is a bill for a transaction that is not yet complete, and the server application is additionally configured to communicate with the mobile device and the point of sale system to enable the user to redeem loyalty program credits in connection with said bill.

22. The system of claim 20, wherein the server application is configured to send an update message to the point of sale system to cause the point of sale system to reduce an amount of the transaction, said update message reflecting a redemption of loyalty program credits of the user.

23. The system of claim 20, further comprising a web server that provides web-based access to the server application.

24. The system of claim 20, further comprising a mobile application that is configured to run on mobile devices of users, said mobile application providing functionality for a customer to scan code images provided on transaction records, and to communicate information extracted from the code images to the server application.

25. The system of claim 24, wherein the mobile application provides a user interface that enables a customer to select, in connection with an open transaction with a merchant, a redemption option for redeeming loyalty program credits.

26. The system of claim 20, further comprising said point of sale system, wherein the point of sale system is configured to incorporate transaction information into coded images provided on transaction records provided to customers.

27. A non-transitory computer-readable medium having stored thereon a mobile application, said mobile application including executable code for directing a mobile device of a user to perform at least the following tasks:
scan a code image generated by a point of sale system of a merchant, said code image comprising transaction information associated with a point of sale transaction with the merchant;
extract the transaction information from the code image; and
transmit the transaction information, and authentication information associated with the user, to a networked computer system that provides functionality for implementing a customer loyalty program.

28. The non-transitory computer-readable medium of claim 27, wherein the mobile application provides a user interface for selectively redeeming loyalty program credits in connection with an open transaction with a merchant.

29. The non-transitory computer-readable medium of claim 27, wherein the transaction information includes a transaction identifier.

30. The non-transitory computer-readable medium of claim 29, wherein the transaction information additionally includes at least one of the following: (1) a point of sale terminal identifier, (2) a point-of-sale system identifier, (3) a timestamp.

31. The non-transitory computer-readable medium of claim 27, wherein the mobile application directs the mobile device to extract the transaction information by a process that comprises decoding a uniform resource identifier from the code image, and extracting the transaction information from the uniform resource identifier.
